(19) United States
(12) Patent Application Publication
(10) Pub. No.: US 2026/0292357 A1
(43) Pub. Date: Sep. 24, 2026

(54) FOVEATED IMAGING BASED ON AUDIO INFORMATION

(71) Applicant: QUALCOMM Incorporated, San Diego, CA (US)

(72) Inventors: Saurabh AGGARWAL, Bengaluru (IN); Rohit RANGANATHAN, Hyderabad (IN); Amrit Anand AMRESH, Bangalore (IN); Animesh BEHERA, Bengaluru (IN)

(21) Appl. No.: 19/088,843

(22) Filed: Mar. 24, 2025

(51) Int. Cl. H04N 23/80; G06F 3/01; H04N 23/60; H04R 1/32

(52) U.S. Cl. CPC H04N 23/815; G06F 3/012; G06F 3/013; H04N 23/64; H04R 1/326

(57) ABSTRACT

Systems and techniques are described herein for processing images. For instance, a method for processing images is provided. The method may include determining a direction related to a sound source in an environment based on audio data captured by a microphone of a device in the environment; determining a probability that a user of the device will look toward the sound source; based on the probability exceeding a threshold, determining a region of interest (ROI) of a field of view (FOV) of a camera of the device based on the direction; and processing image data captured by the camera based on the ROI.

### TECHNICAL FIELD

The present disclosure generally relates to foveated imaging. For example, aspects of the present disclosure include systems and techniques for foveated capturing, processing, displaying, and/or storing of image data.

### BACKGROUND

Extended reality (XR) technologies can be used to present virtual content to users, and/or can combine real environments from the physical world and virtual environments to provide users with XR experiences. The term XR can encompass virtual reality (VR), augmented reality (AR), mixed reality (MR), and the like. XR systems can allow users to experience XR environments by overlaying virtual content onto a user's view of a real-world environment. For example, an XR head-mounted device (HMD) may include a display that allows a user to view the user's real-world environment through a display of the HMD (e.g., a transparent display). The XR HMD may display virtual content at the display in the user's field of view overlaying the user's view of their real-world environment. Such an implementation may be referred to as “see-through” XR. As another example, an XR HMD may include a scene-facing camera that may capture images of the user's real-world environment. The XR HMD may modify or augment the images (e.g., adding virtual content) and display the modified images to the user. Such an implementation may be referred to as “pass through” XR or as “video see through (VST).” The user can generally change their view of the environment interactively, for example by tilting or moving the XR HMD.

A foveated image is an image with different resolutions in different regions within the image. For example, a foveated image may include a highest resolution in a region of interest (ROI) and one or more lower-resolution regions around the ROI (e.g., in one or more “peripheral regions”).

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for processing images. According to at least one example, a method is provided for processing images. The method includes: determining a direction related to a sound source in an environment based on audio data captured by a microphone of a device in the environment; determining a probability that a user of the device will look toward the sound source; based on the probability exceeding a threshold, determining a region of interest (ROI) of a field of view (FOV) of a camera of the device based on the direction; and processing image data captured by the camera based on the ROI.

In another example, an apparatus for processing images is provided that includes at least one memory and at least one processor (e.g., configured in circuitry) coupled to the at least one memory. The at least one processor configured to: determine a direction related to a sound source in an environment based on audio data captured by a microphone of a device in the environment; determine a probability that a user of the device will look toward the sound source; based on the probability exceeding a threshold, determine a region of interest (ROI) of a field of view (FOV) of a camera of the device based on the direction; and process image data captured by the camera based on the ROI.

In another example, a non-transitory computer-readable medium is provided that has stored thereon instructions that, when executed by one or more processors, cause the one or more processors to: determine a direction related to a sound source in an environment based on audio data captured by a microphone of a device in the environment; determine a probability that a user of the device will look toward the sound source; based on the probability exceeding a threshold, determine a region of interest (ROI) of a field of view (FOV) of a camera of the device based on the direction; and process image data captured by the camera based on the ROI.

In another example, an apparatus for processing images is provided. The apparatus includes: means for determining a direction related to a sound source in an environment based on audio data captured by a microphone of a device in the environment; means for determining a probability that a user of the device will look toward the sound source; means for based on the probability exceeding a threshold, determining a region of interest (ROI) of a field of view (FOV) of a camera of the device based on the direction; and means for processing image data captured by the camera based on the ROI.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example extended-reality (XR) system, according to aspects of the disclosure;

FIG. 2 is a block diagram illustrating an architecture of an example XR system, in accordance with some aspects of the disclosure;

FIG. 3 is a block diagram illustrating an example system to illustrate a video-see-through (VST) dataflow;

FIG. 4 includes an example foveated image;

FIG. 5 includes an illustration of an example foveated image, according to various aspects of the present disclosure;

FIG. 6 is a block diagram illustrating an example system for processing foveated image data, according to various aspects of the present disclosure;

FIG. 7 is a block diagram illustrating an example system for processing foveated image data, according to various aspects of the present disclosure;

FIG. 8 is a diagram illustrating an example scenario in which an XR device may determine a region of interest (ROI) and/or capture, process, render, and/or display image data based on ROI according to various aspects of the present disclosure;

FIG. 9 is a block diagram illustrating an example system for determining an ROI based on sound, according to various aspects of the present disclosure;

FIG. 10A includes an example foveated image including an ROI determined according to various aspects of the present disclosure;

FIG. 10B includes another example foveated image including another ROI determined according to various aspects of the present disclosure;

FIG. 10C includes yet another example foveated image including yet another ROI determined according to various aspects of the present disclosure;

FIG. 10D includes yet another example foveated image including yet another ROI determined according to various aspects of the present disclosure;

FIG. 11 is a flow diagram illustrating an example process that may be used in determining an ROI according to various aspects of the present disclosure;

FIG. 12 is a block diagram of an example system that may determine an ROI according to various aspects of the present disclosure;

FIG. 13 includes a block diagram of an example system, that may capture, process, render, and/or display foveated image data, according to various aspects of the present disclosure;

FIG. 14 is a flow diagram illustrating an example process for determining an ROI, in accordance with aspects of the present disclosure;

FIG. 15 is a block diagram illustrating an example of a deep learning neural network that can be used to perform various tasks, according to some aspects of the disclosed technology;

FIG. 16 is a block diagram illustrating an example of a convolutional neural network (CNN), according to various aspects of the present disclosure; and

FIG. 17 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As noted previously, an extended reality (XR) system or device can provide a user with an XR experience by presenting virtual content to the user (e.g., for a completely immersive experience) and/or can combine a view of a real-world or physical environment with a display of a virtual environment (made up of virtual content). The real-world environment can include real-world objects (also referred to as physical objects), such as people, vehicles, buildings, tables, chairs, and/or other real-world or physical objects. As used herein, the terms XR system and XR device are used interchangeably. Examples of XR systems or devices include head-mounted displays (HMDs) (which may also be referred to as a head-mounted devices), XR glasses (e.g., AR glasses, MR glasses, etc.) (also referred to as smart or network-connected glasses), among others. In some cases, XR glasses are an example of an HMD. In some cases, an XR system can track parts of the user (e.g., a hand and/or fingertips of a user) to allow the user to interact with items of virtual content.

XR systems can include virtual reality (VR) systems facilitating interactions with VR environments, augmented reality (AR) systems facilitating interactions with AR environments, mixed reality (MR) systems facilitating interactions with MR environments, and/or other XR systems.

For instance, VR provides a complete immersive experience in a three-dimensional (3D) computer-generated VR environment or video depicting a virtual version of a real-world environment. VR content can include VR video in some cases, which can be captured and rendered at very high quality, potentially providing a truly immersive virtual reality experience. Virtual reality applications can include gaming, training, education, sports video, online shopping, among others. VR content can be rendered and displayed using a VR system or device, such as a VR HMD or other VR headset, which fully covers a user's eyes during a VR experience.

AR is a technology that provides virtual or computer-generated content (referred to as AR content) over the user's view of a physical, real-world scene or environment. AR content can include virtual content, such as video, images, graphic content, location data (e.g., global positioning system (GPS) data or other location data), sounds, any combination thereof, and/or other augmented content. An AR system or device is designed to enhance (or augment), rather than to replace, a person's current perception of reality. For example, a user can see a real stationary or moving physical object through an AR device display, but the user's visual perception of the physical object may be augmented or enhanced by a virtual image of that object (e.g., a real-world car replaced by a virtual image of a DeLorean), by AR content added to the physical object (e.g., virtual wings added to a live animal), by AR content displayed relative to the physical object (e.g., informational virtual content displayed near a sign on a building, a virtual coffee cup virtually anchored to (e.g., placed on top of) a real-world table in one or more images, etc.), and/or by displaying other types of AR content. Various types of AR systems can be used for gaming, entertainment, and/or other applications.

MR technologies can combine aspects of VR and AR to provide an immersive experience for a user. For example, in an MR environment, real-world and computer-generated objects can interact (e.g., a real person can interact with a virtual person as if the virtual person were a real person).

An XR environment can be interacted with in a seemingly real or physical way. As a user experiencing an XR environment (e.g., an immersive VR environment) moves in the real world, rendered virtual content (e.g., images rendered in a virtual environment in a VR experience) also changes, giving the user the perception that the user is moving within the XR environment. For example, a user can turn left or right, look up or down, and/or move forwards or backwards, thus changing the user's point of view of the XR environment. The XR content presented to the user can change accordingly, so that the user's experience in the XR environment is as seamless as it would be in the real world.

In some cases, an XR system can match the relative pose and movement of objects and devices in the physical world. For example, an XR system can use tracking information to calculate the relative pose of devices, objects, and/or features of the real-world environment in order to match the relative position and movement of the devices, objects, and/or the real-world environment. In some examples, the XR system can use the pose and movement of one or more devices, objects, and/or the real-world environment to render content relative to the real-world environment in a convincing manner. The relative pose information can be used to match virtual content with the user's perceived motion and the spatio-temporal state of the devices, objects, and real-world environment. In some cases, an XR system can track parts of the user (e.g., a hand and/or fingertips of a user) to allow the user to interact with items of virtual content.

XR systems or devices can facilitate interaction with different types of XR environments (e.g., a user can use an XR system or device to interact with an XR environment). One example of an XR environment is a metaverse virtual environment. A user may virtually interact with other users (e.g., in a social setting, in a virtual meeting, etc.), virtually shop for items (e.g., goods, services, property, etc.), to play computer games, and/or to experience other services in a metaverse virtual environment. In one illustrative example, an XR system may provide a 3D collaborative virtual environment for a group of users. The users may interact with one another via virtual representations of the users in the virtual environment. The users may visually, audibly, haptically, or otherwise experience the virtual environment while interacting with virtual representations of the other users.

A virtual representation of a user may be used to represent the user in a virtual environment. A virtual representation of a user is also referred to herein as an avatar. An avatar representing a user may mimic an appearance, movement, mannerisms, and/or other features of the user. In some examples, the user may desire that the avatar representing the person in the virtual environment appear as a digital twin of the user. In any virtual environment, it is important for an XR system to efficiently generate high-quality avatars (e.g., realistically representing the appearance, movement, etc. of the person) in a low-latency manner. It can also be important for the XR system to render audio in an effective manner to enhance the XR experience.

In some cases, an XR system can include an optical “see-through” or “pass-through” display (e.g., see-through or pass-through AR HMD or AR glasses), allowing the XR system to display XR content (e.g., AR content) directly onto a real-world view without displaying video content. For example, a user may view physical objects through a display (e.g., glasses or lenses), and the AR system can display AR content onto the display to provide the user with an enhanced visual perception of one or more real-world objects. In one example, a display of an optical see-through AR system can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world.

As noted previously, a foveated image may have different resolutions in different regions within the image. For example, a foveated image may include a highest resolution in a region of interest (ROI) and one or more lower-resolution regions around the ROI (e.g., in one or more “peripheral regions”).

A foveated-image sensor can be configured to capture an image of an ROI of a field of view (FOV) in high resolution. The image may be referred to as a “fovea region” or an “ROI.” The foveated-image sensor may also capture another image of the full field of view at a lower resolution. The portion of the lower-resolution image that is outside the ROI may be referred to as the peripheral region. The image of the ROI may be inset into the other image of the peripheral region. The combine image may be referred to as a foveated image. In some aspects, foveated-image capture may operate at multiple tiers of resolution, for example, with an ROI at a highest resolution, a first-tier peripheral region (e.g., outside the ROI) at a second-highest resolution, a second-tier peripheral region (e.g., outside the first-tier peripheral region) at a third-highest resolution, etc.

Additionally or alternatively, a processor can render or process a foveated image with image data of an ROI at a higher resolution and image data of a peripheral region at a lower resolution. For example, an image sensor may load image data into memory (the image data may be foveated image data or images data with all the pixels at the same resolution). When processing the image data, an image processor may retrieve the image data from the memory at different resolutions. For example, the image processor may retrieve pixels of an ROI at a first resolution and pixels of a peripheral region at a second resolution. The image processor may process the retrieved pixels. Additionally or alternatively, an image processor may perform different image processing techniques, or a different number of processing operations for different regions. For example, the image processor may process pixels of an ROI using a first number of image-processing operations and pixels of a peripheral region using a second number of image-processing operations.

Additionally or alternatively, a processor, a display driver, and/or a display may display foveated image with image data of an ROI displayed at a higher resolution and image data of a peripheral region displayed at a lower resolution. For example, a display driver may receive images data from an image processor. The display driver may cause a display to display pixels in an ROI at a first resolution and pixels in a peripheral region at a second resolution.

XR applications may benefit from foveated image capturing, rendering, processing, and/or displaying. For example, some XR head-mounted displays (HMDs) may render, process, and/or display foveated image data, (e.g., virtual content to be displayed at the HMD) in a foveated manner. The image data may be rendered, processed, and/or displayed at different qualities and/or resolutions at different regions of the image data. For example, the image data may be rendered at a highest resolution and/or quality in an ROI and at a lower resolution and/or quality outside the ROI.

As an example, some XR HMDs may implement video see through (VST). In VST, an XR HMD may capture images of a field of view of a user and display the images to the user as if the user were viewing the field of view directly. While displaying the images of the field of view, the XR HMD may alter or augment the images providing the user with an altered or augmented view of the environment of the user (e.g., providing the user with an XR experience). VST may benefit from foveated image capture, foveated image processing, foveated image rendering and/or foveated image display.

Foveated image capturing, rendering, processing, and/or displaying may be useful in XR because foveated-image sensing, rendering, processing, and/or displaying may allow an XR HMD to conserve computational resources (e.g., power, processing time, communication bandwidth etc.). For example, a foveated image of a field of view (or a smaller area) may be smaller in data size than a full-resolution image of the same field of view (or the same smaller area) because the peripheral region of the foveated image may have lower resolution and may be stored using less data. Thus, capturing, storing, processing, rendering, and/or displaying a foveated image rather than a full-resolution image may conserve computational resources.

Some devices may capture, process, render, and/or display foveated images based on a gaze of a user. For example, some devices (e.g., XR HMDs) may determine a gaze of a view (e.g., where the viewer is gazing within an image frame) and determine an ROI for foveated imaging based on the gaze. The device may then capture, render, process, and/or display image data (e.g., foveated image data) to have the highest resolution in the ROI and lower resolution outside the ROI (e.g., at “peripheral regions”).

Foveated sensing (e.g., capturing foveated image data) relies on accurate gaze detection (e.g., using eye-tracking cameras). For example, one or more eye-tracking cameras may capture images of a user's eyes. A gaze-detection algorithm may determine where the user is gazing (e.g., relative to an FoV of a scene-facing camera). The gaze-detection algorithm may provide an indication of the gaze to the scene-facing camera. The scene-facing camera may update its image signal processing (ISP) parameters. Software of the scene-facing camera may update an ROI location The scene-facing camera may update the ROI location and capture new image data based on the updated ROI.

The time it takes to perform foveated sensing may be referred to as a latency (e.g., between a when a gaze changes, when the changed gaze is detected, and when the ROI update is implemented by the scene-facing camera). This process may take time (e.g., hundreds of milli-second). During this delay, a user's gaze may change. If the user's gaze changes, by the time a foveated image is captured, processed, and displayed, the user may not be gazing at the ROI of the foveated image (or at least not at the center of the ROI).

One approach to accounting for such inaccuracies in gaze detection is to add a margin around a ROI (e.g., to increase a size of an ROI) such that if the center of the predicted ROI does not align with the center of the user's gaze, the center of the user's gaze will be within the enlarged ROI. However, increasing the size of the ROI increases the data size of foveated images, which increases power and/or bandwidth consumption, and in general reducing the benefit of foveated sensing.

While visual information, like eye images and scene content, provides a source of inputs for gaze detection algorithms, such visually information may not be sufficient to pre-empt or predict changes in user gaze. For example, such visual information may not include visual content outside the FOV of scene-facing cameras.

Systems, apparatuses, methods (also referred to as processes), and computer-readable media (collectively referred to herein as “systems and techniques”) are described herein for foveated imaging. For example, the systems and techniques described herein may determine inputs to gaze-detection algorithms based on audio information from the environment. The audio inputs may allow gaze-detection algorithms to adjust margins to achieve a better combination of perceptual quality and power/bandwidth consumption than are possible using only visual information. Additionally, audio data (e. g, 3D audio detections) can cover a large field as compared to scene-facing cameras which are limited by their FOV.

The systems and techniques may detect sound using sound sensors (e.g., microphones) present on a device (e.g., an HMD). Further, the systems and techniques may run digital signal processing (DSP) algorithms to filter out ambient noise and estimate a position of a source of the sound in the environment. The systems and techniques may predict head motion and/or gaze change based on the estimated position of sound source. Further, the systems and techniques may adjust the ROI margins and/or gaze position appropriately.

In some aspects, the systems and techniques may determine a priority associated with sounds and predict the head motion and/or gaze change based on the priority associated with sounds. Further, in some aspects, priority estimation for different sound sources can be learned over time based on users'reactions to different audio stimuli.

In general, the average response time of humans to audio stimuli may be about 160 milliseconds (ms). For example, users will start to move their heads and shift their gaze towards a sound source about 160 ms after hearing a sound from the sound source. Therefore, there is a window of about 160 ms for the systems and techniques to adjust the margins of an ROI.

Because the systems and techniques improve the accuracy of gaze prediction and/or ROI determination, the systems and techniques allow for pre-emptively reducing ROI margins even in steady state (e.g., when a user is not moving their head/gaze). Thus the systems and techniques may reduce bandwidth and/or power consumption while maintaining perceptual quality.

Various aspects of the application will be described with respect to the figures below.

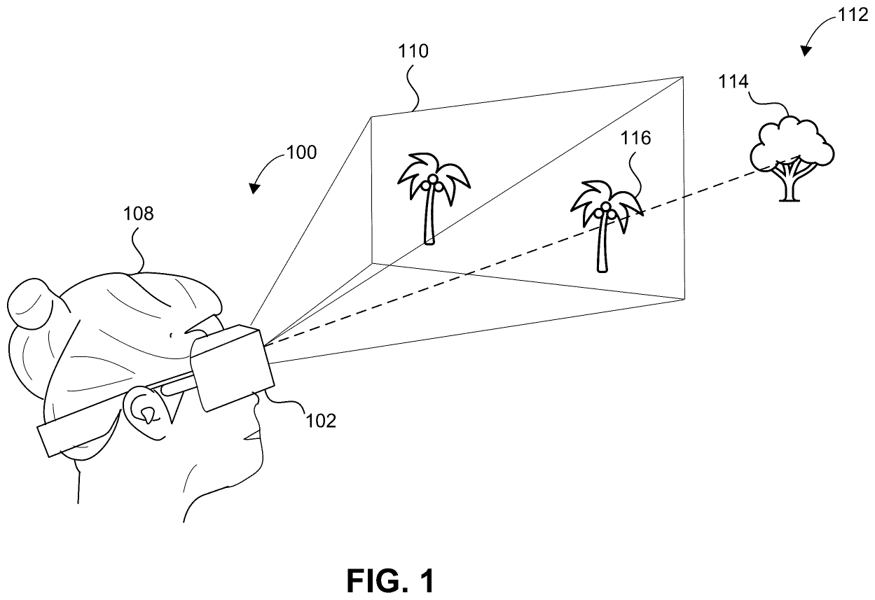

FIG. 1 is a diagram illustrating an example extended-reality (XR) system 100, according to aspects of the disclosure. As shown, XR system 100 includes an XR device 102. XR device 102 may implement, as examples, image-capture, object-detection, object-tracking, gaze-tracking, view-tracking, localization (e.g., determining a location of XR device 102), pose-tracking (e.g., tracking a pose of XR device 102 and/or a pose of one or more objects in scene 112), content-generation, content-rendering, computational, communicational, and/or display aspects of extended reality, including virtual reality (VR), augmented reality (AR), and/or mixed reality (MR).

For example, XR device 102 may include one or more scene-facing cameras that may capture images of a scene 112 in which a user 108 uses XR device 102. XR device 102 may detect and/or track objects (e.g., object 114) in scene 112 based on the images of scene 112. In some aspects, XR device 102 may include one or more user-facing cameras that may capture images of eyes of user 108. XR device 102 may determine a gaze of user 108 based on the images of user 108. In some aspects, XR device 102 may determine an object of interest (e.g., object 114) in scene 112 (e.g., based on the gaze of user 108, based on object recognition, and/or based on a received indication regarding object 114). XR device 102 may obtain and/or render XR content 116 (e.g., text, images, and/or video) for display at XR device 102. XR device 102 may display XR content 116 to user 108 (e.g., within a field of view 110 of user 108). In some aspects, XR content 116 may be based on and/or anchored to points in scene 112. For example, XR content 116 may be, or may include, an altered version of object 114 (e.g., based on an XR application running at XR device 102) anchored to object 114 in scene 112. The XR application may provide user 108 with an XR experience by altering scene 112 in view 110 of user 108. In some aspects, XR device 102 may display XR content 116 in relation to the view of user 108 of the object of interest. For example, XR device 102 may overlay XR content 116 onto object 114 in field of view 110. In any case, XR device 102 may overlay XR content 116 (whether related to object 114 or not) onto the view of user 108 of scene 112. For example, object 114 may be a cherry tree. Based on an XR application running at XR device 102, XR device 102 may anchor XR content 116, which may be a palm tree, to object 114 such that in the view of user 108, user 108 sees XR content 116 (the palm tree) and not object 114 (the cherry tree).

In a “see-through” or “transparent” configuration, XR device 102 may include a transparent surface (e.g., optical glass) such that XR content 116 may be displayed on (e.g., by being projected onto) the transparent surface to overlay the view of user 108 of scene 112 as viewed through the transparent surface. In a “pass-through” configuration or a “video see-through” configuration, XR device 102 may include a scene-facing camera that may capture images of scene 112. XR device 102 may display images or video of scene 112, as captured by the scene-facing camera, and XR content 116 overlaid on the images or video of scene 112.

In various examples, XR device 102 may be, or may include, a head-mounted device (HMD), a virtual reality headset, and/or smart glasses. XR device 102 may include one or more cameras, including scene-facing cameras and/or user-facing cameras, a GPU, one or more sensors (e.g., such as one or more inertial measurement units (IMUs), image sensors, and/or microphones), one or more communication units (e.g., wireless communication units), and/or one or more output devices (e.g., such as speakers, headphones, display, and/or smart glass).

In some aspects, XR device 102 may be, or may include, two or more devices. For example, XR device 102 may include a display device and a processing device. The display device may capture and/or generate data, such as image data (e.g., from user-facing cameras and/or scene-facing cameras) and/or motion data (from an inertial measurement unit (IMU)). The display device may provide the data to the processing device, for example, through a wireless connection between the display device and the processing device. The processing device may process the data and/or other data (e.g., data received from another source). Further, the processing unit may generate (or obtain) XR content 116 to be displayed at the display device. The processing device may provide the generated XR content 116 to the display device, for example, through the wireless connection. And the display device may display XR content 116 in field of view 110 of user 108.

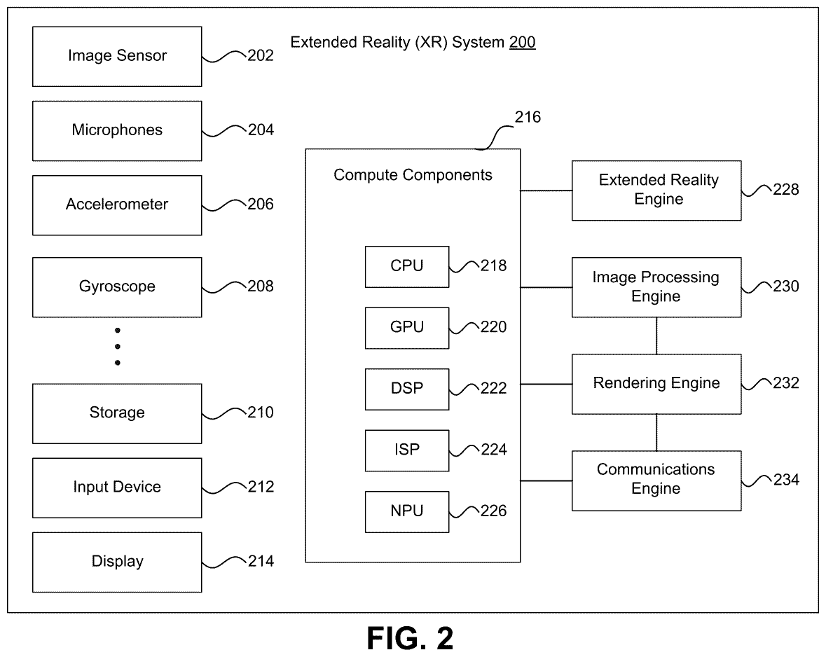

FIG. 2 is a diagram illustrating an architecture of an example extended reality (XR) system 200, in accordance with some aspects of the disclosure. XR system 200 may execute XR applications and implement XR operations.

In this illustrative example, XR system 200 includes one or more image sensors 202, an accelerometer 206, a gyroscope 208, microphones 204, storage 210, an input device 212, a display 214, Compute components 216, an XR engine 228, an image processing engine 230, a rendering engine 232, and a communications engine 234. It should be noted that the components 202-234 shown in FIG. 2 are non-limiting examples provided for illustrative and explanation purposes, and other examples may include more, fewer, or different components than those shown in FIG. 2. For example, in some cases, XR system 200 may include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one more other processing engines, one or more other hardware components, and/or one or more other software and/or hardware components that are not shown in FIG. 2. While various components of XR system 200, such as image sensor 202, may be referenced in the singular form herein, it should be understood that XR system 200 may include multiple of any component discussed herein (e.g., multiple image sensors 202).

Display 214 may be, or may include, a glass, a screen, a lens, a projector, and/or other display mechanism that allows a user to see the real-world environment and also allows XR content to be overlaid, overlapped, blended with, or otherwise displayed thereon.

XR system 200 may include, or may be in communication with, (wired or wirelessly) an input device 212. Input device 212 may include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, image sensor 202 may capture images that may be processed for interpreting gesture commands.

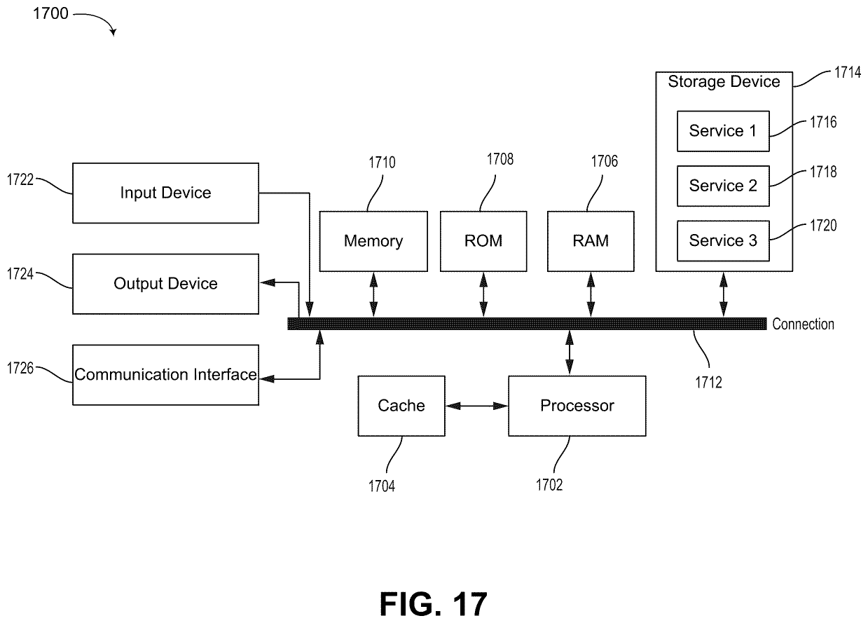

XR system 200 may also communicate with one or more other electronic devices (wired or wirelessly). For example, communications engine 234 may be configured to manage connections and communicate with one or more electronic devices. In some cases, communications engine 234 may correspond to communication interface 1726 of FIG. 17.

In some implementations, image sensors 202, accelerometer 206, gyroscope 208, microphones 204, storage 210, display 214, compute components 216, XR engine 228, image processing engine 230, and rendering engine 232 may be part of the same computing device. For example, in some cases, image sensors 202, accelerometer 206, gyroscope 208, microphones 204, storage 210, display 214, compute components 216, XR engine 228, image processing engine 230, and rendering engine 232 may be integrated into an HMD, extended reality glasses, smartphone, laptop, tablet computer, gaming system, and/or any other computing device. However, in some implementations, image sensors 202, accelerometer 206, gyroscope 208, microphones 204, storage 210, display 214, compute components 216, XR engine 228, image processing engine 230, and rendering engine 232 may be part of two or more separate computing devices. For instance, in some cases, some of the components 202-234 may be part of, or implemented by, one computing device and the remaining components may be part of, or implemented by, one or more other computing devices. For example, such as in a split perception XR system, XR system 200 may include a first device (e.g., an HMD), including display 214, image sensor 202, accelerometer 206, gyroscope 208, microphones 204. and/or one or more compute components 216. XR system 200 may also include a second device including additional compute components 216 (e.g., implementing XR engine 228, image processing engine 230, rendering engine 232, and/or communications engine 234). In such an example, the second device may generate virtual content based on information or data (e.g., images captured by image sensor 202, audio data captured by microphones 204, sensor data such as measurements from accelerometer 206 and gyroscope 208) and may provide the virtual content to the first device for display at the first device. The second device may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Storage 210 may be any storage device(s) for storing data. Moreover, storage 210 may store data from any of the components of XR system 200. For example, storage 210 may store data from image sensor 202 (e.g., image or video data), audio data from microphones 204, data from accelerometer 206 (e.g., measurements), data from gyroscope 208 (e.g., measurements), data from compute components 216 (e.g., processing parameters, preferences, virtual content, rendering content, scene maps, tracking and localization data, object detection data, privacy data, XR application data, face recognition data, occlusion data, etc.), data from XR engine 228, data from image processing engine 230, and/or data from rendering engine 232 (e.g., output frames). In some examples, storage 210 may include a buffer for storing frames for processing by compute components 216.

Compute components 216 may be, or may include, a central processing unit (CPU) 218, a graphics processing unit (GPU) 220, a digital signal processor (DSP) 222, an image signal processor (ISP) 224, a neural processing unit (NPU) 226, which may implement one or more trained neural networks, and/or other processors. Compute components 216 may perform various operations such as image enhancement, computer vision, graphics rendering, extended reality operations (e.g., tracking, localization, pose estimation, mapping, content anchoring, content rendering, predicting, etc.), image and/or video processing, sensor processing, recognition (e.g., text recognition, facial recognition, object recognition, feature recognition, tracking or pattern recognition, scene recognition, occlusion detection, etc.), trained machine-learning operations, filtering, and/or any of the various operations described herein. In some examples, compute components 216 may implement (e.g., control, operate, etc.) XR engine 228, image processing engine 230, and rendering engine 232. In other examples, compute components 216 may also implement one or more other processing engines.

Image sensor 202 may include any image and/or video sensors or capturing devices. In some examples, image sensor 202 may be part of a multiple-camera assembly, such as a dual-camera assembly. Image sensor 202 may capture image and/or video content (e.g., raw image and/or video data), which may then be processed by compute components 216, XR engine 228, image processing engine 230, and/or rendering engine 232 as described herein.

In some examples, image sensor 202 may capture image data and may generate images (also referred to as frames) based on the image data and/or may provide the image data or frames to XR engine 228, image processing engine 230, and/or rendering engine 232 for processing. An image or frame may include a video frame of a video sequence or a still image. An image or frame may include a pixel array representing a scene. For example, an image may be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, image sensor 202 (and/or other camera of XR system 200) may be configured to also capture depth information. For example, in some implementations, image sensor 202 (and/or other camera) may include an RGB-depth (RGB-D) camera. In some cases, XR system 200 may include one or more depth sensors (not shown) that are separate from image sensor 202 (and/or other camera) and that may capture depth information. For instance, such a depth sensor may obtain depth information independently from image sensor 202. In some examples, a depth sensor may be physically installed in the same general location or position as image sensor 202 but may operate at a different frequency or frame rate from image sensor 202. In some examples, a depth sensor may take the form of a light source that may project a structured or textured light pattern, which may include one or more narrow bands of light, onto one or more objects in a scene. Depth information may then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

Microphones 204 may include two or more microphones positioned on XR system 200. In some aspects, microphones 204 may include an array of microphones. Microphones 204 may detect sound and compute components 216 may triangulate (e.g., using time difference of arrival (TDOA)) a direction to a source of the sound or a position of the source of the sound in the environment based on the sound as captured by microphones 204.

XR system 200 may also include other sensors in its one or more sensors. The one or more sensors may include one or more accelerometers (e.g., accelerometer 206), one or more gyroscopes (e.g., gyroscope 208), and/or other sensors. The one or more sensors may provide velocity, orientation, and/or other position-related information to compute components 216. For example, accelerometer 206 may detect acceleration by XR system 200 and may generate acceleration measurements based on the detected acceleration. In some cases, accelerometer 206 may provide one or more translational vectors (e.g., up/down, left/right, forward/back) that may be used for determining a position or pose of XR system 200. Gyroscope 208 may detect and measure the orientation and angular velocity of XR system 200. For example, gyroscope 208 may be used to measure the pitch, roll, and yaw of XR system 200. In some cases, gyroscope 208 may provide one or more rotational vectors (e.g., pitch, yaw, roll). In some examples, image sensor 202 and/or XR engine 228 may use measurements obtained by accelerometer 206 (e.g., one or more translational vectors) and/or gyroscope 208 (e.g., one or more rotational vectors) to calculate the pose of XR system 200. As previously noted, in other examples, XR system 200 may also include other sensors, such as a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors may include at least one IMU. An IMU is an electronic device that measures the specific force, angular rate, and/or the orientation of XR system 200, using a combination of one or more accelerometers, one or more gyroscopes, and/or one or more magnetometers. For example, an IMU of XR system 200 may include accelerometer 206, gyroscope 208, and/or a magnetometer. In some examples, the one or more sensors may output measured information associated with the capture of an image captured by image sensor 202 (and/or other camera of XR system 200) and/or depth information obtained using one or more depth sensors of XR system 200.

The output of one or more sensors (e.g., accelerometer 206, gyroscope 208, and/or other sensors) can be used by XR engine 228 to determine a pose of XR system 200 (also referred to as the head pose) and/or the pose of image sensor 202 (or other camera of XR system 200). In some cases, the pose of XR system 200 and the pose of image sensor 202 (or other camera) can be the same. The pose of image sensor 202 refers to the position and orientation of image sensor 202 relative to a frame of reference (e.g., with respect to a field of view 110 of FIG. 1). In some implementations, the camera pose can be determined for 6-Degrees of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees of Freedom (3DoF), which refers to the three angular components (e.g. roll, pitch, and yaw).

In some cases, a device tracker (not shown) can use the measurements from the one or more sensors and image data from image sensor 202 to track a pose (e.g., a 6DoF pose) of XR system 200. For example, the device tracker can fuse visual data (e.g., using a visual tracking solution) from the image data with inertial data from the measurements to determine a position and motion of XR system 200 relative to the physical world (e.g., the scene) and a map of the physical world. As described below, in some examples, when tracking the pose of XR system 200, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of XR system 200 within the scene and the 3D map of the scene, etc. The 3D map can provide a digital representation of a scene in the real/physical world. In some examples, the 3D map can anchor position-based objects and/or content to real-world coordinates and/or objects. XR system 200 can use a mapped scene (e.g., a scene in the physical world represented by, and/or associated with, a 3D map) to merge the physical and virtual worlds and/or merge virtual content or objects with the physical environment.

In some aspects, the pose of image sensor 202 and/or XR system 200 as a whole can be determined and/or tracked by compute components 216 using a visual tracking solution based on images captured by image sensor 202 (and/or other camera of XR system 200). For instance, in some examples, compute components 216 can perform tracking using computer vision-based tracking, model-based tracking, and/or simultaneous localization and mapping (SLAM) techniques. For instance, compute components 216 can perform SLAM or can be in communication (wired or wireless) with a SLAM system (not shown). SLAM refers to a class of techniques where a map of an environment (e.g., a map of an environment being modeled by XR system 200) is created while simultaneously tracking the pose of a camera (e.g., image sensor 202) and/or XR system 200 relative to that map. The map can be referred to as a SLAM map which can be three-dimensional (3D). The SLAM techniques can be performed using color or grayscale image data captured by image sensor 202 (and/or other camera of XR system 200) and can be used to generate estimates of 6DoF pose measurements of image sensor 202 and/or XR system 200. Such a SLAM technique configured to perform 6DoF tracking can be referred to as 6DoF SLAM. In some cases, the output of the one or more sensors (e.g., accelerometer 206, gyroscope 208, and/or other sensors) can be used to estimate, correct, and/or otherwise adjust the estimated pose.

In some cases, the 6DoF SLAM (e.g., 6DoF tracking) can associate features observed from certain input images from the image sensor 202 (and/or other camera) to the SLAM map. For example, 6DoF SLAM can use feature point associations from an input image to determine the pose (position and orientation) of the image sensor 202 and/or XR system 200 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 202 and/or the XR system 200 can be determined by projecting features from the 3D SLAM map into an image or video frame and updating the camera pose from verified 2D-3D correspondences.

In one illustrative example, the compute components 216 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

As one illustrative example, the compute components 216 can extract feature points corresponding to a mobile device, or the like. In some cases, feature points corresponding to the mobile device can be tracked to determine a pose of the mobile device. As described in more detail below, the pose of the mobile device can be used to determine a location for projection of AR media content that can enhance media content displayed on a display of the mobile device.

In some cases, the XR system 200 can also track the hand and/or fingers of the user to allow the user to interact with and/or control virtual content in a virtual environment. For example, the XR system 200 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

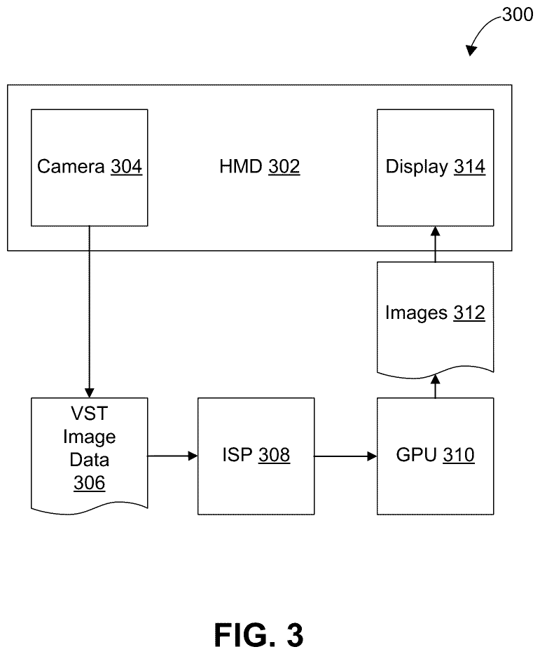

FIG. 3 is a block diagram illustrating an example system 300 to illustrate a video-see-through (VST) dataflow. For example, a camera 304 (e.g., a scene-facing camera) of a head-mounted device (HMD) 302 (such as XR system 100) may capture VST image data 306 (e.g., images of a scene). VST image data 306 may be processed at an image signal processor (ISP) 308 and/or a graphics processing unit (GPU) 310 and the resulting processed images 312 may be displayed at a display 314 of HMD 302. In some aspects, ISP 308 and/or GPU 310 may be included in HMD 302. Additionally or alternatively, a separate computing device (such as a companion device) may include ISP 308 and/or GPU 310.

Processing image data at ISP 308, GPU 310, and/or other processors may consume computational resources (such as power and processing time). Additionally, communicating VST image data 306 to ISP 308, GPU 310, other processors, and display 314 may take communication bandwidth (and/or power). Communicating VST image data 306 may consume bandwidth in cases when ISP 308 and/or GPU 310 are part of a separate computing devices (such as a companion device).

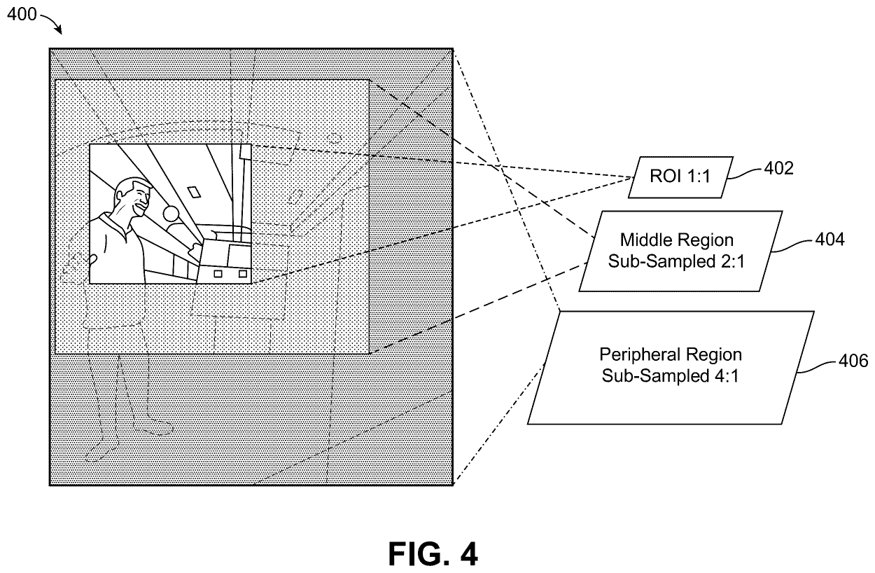

FIG. 4 includes an example foveated image 400. Foveated image 400 includes a region of interest (ROI) 402 having a first resolution. The first resolution may be described as a 1:1 resolution. For example, for every pixel captured by an image sensor, ROI 402 may include one pixel. Thus the resolution of ROI 402 may be the highest resolution that can be captured by the image sensor.

Foveated image 400 may additionally include middle region 404 which has a second resolution. The second resolution, for example, may be described as 2:1. For example, for every 2×2 block of pixels captured by the image sensor, middle region 404 may include one pixel. Thus middle region 404 may be subsampled (e.g., downsampled by a factor of two in two directions) relative to the highest resolution image data that can be captured by the image sensor. Thus, middle region 404 may have a resolution that is one quarter (e.g., half in each direction) of the resolution of image data at the highest resolution of the image sensor.

The size of ROI 402 and/or middle region 404 may be determined based on an ability of a person to focus on and resolve pixels in a region of the person's field of view. For example, the size of ROI 402 may be based on how well a person looking at ROI 402 is able to notice a lower resolution outside ROI 402. Similarly, the size of middle region 404 may be based on how well a person looking at middle region 404 is able to notice a lower resolution outside middle region 404.

Foveated image 400 may include additional middle areas and/or peripheral areas. For example, foveated image 400 includes peripheral region 406 which has a third resolution. The third resolution, for example, may be described as 4:1. For example, for every 4×4 block of pixels captured by the image sensor, peripheral region 406 may include one pixel. Thus peripheral region 406 may be subsampled (e.g., downsampled by a factor of four in both directions) relative to the highest resolution image data that can be captured by the image sensor. Thus, peripheral region 406 may have a resolution that is one sixteenth the resolution of image data at the highest resolution of the image sensor.

A foveated image, according to various aspects of the present disclosure, may have any number of ROIs and/or any number of middle regions and/or peripheral regions. The ROIs, middle regions, and/or peripheral regions may, or may not, be rectangular.

If a VST pipeline (such as system 300 of FIG. 3) uses foveated image data rather than full-resolution image data (e.g., image data including all the pixels captured by an image sensor), the VST pipeline may conserve computational resources. For example, by storing, processing, and transmitting foveated image data (e.g., foveated image 400), the VST pipeline may store, process, and transmit less data and may thereby conserve computational resources.

In some aspects, an ROI may be determined based on a gaze of a viewer of the display. For example, a gaze of a viewer may be tracked and the position of ROI 402 within foveated image 400 may be determined based on the gaze. Because the viewer is gazing at ROI 402, and because ROI 402 has a full resolution, the user's experience may not be diminished by the lower resolution of middle region 404 and peripheral region 406.

Peripheral region 406 may include pixels (at the third resolution) for the full frame of foveated image 400. As such, peripheral region 406 may include pixels (at the third resolution) overlapping middle region 404 and ROI 402. Similarly, middle region 404 may include pixels (at the second resolution) for the full area of middle region 404. As such, middle region 404 may include pixels (at the second resolution) overlapping ROI 402.

One approach for accounting for a delay between capturing image of eyes of a user and determining and implementing an updated ROI is to generate an ROI of an image that is larger than what would otherwise be needed. For example, the enlarged ROI may be larger than a region outside which a person, if gazing at the center of the region, can distinguish a between a higher resolution and a lower resolution.

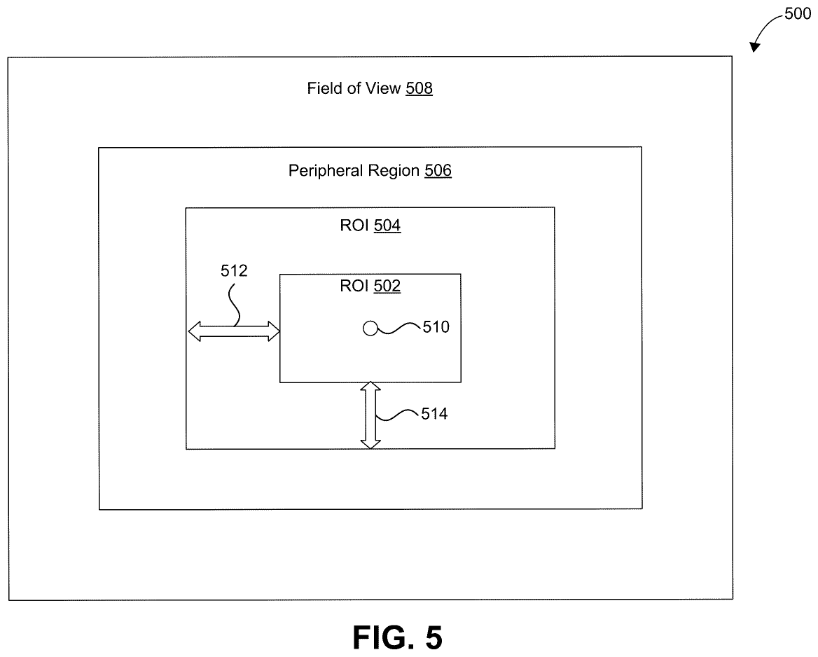

For example, FIG. 5 includes an illustration of an example foveated image 500 including a ROI 502, a ROI 504, a peripheral region 506, and a field of view 508, according to various aspects of the present disclosure. A system (e.g., system 300) may capture and/or process image data of ROI 502 at a high resolution. For example, the system may determine ROI 502 based on gaze center 510 (e.g., a determined center of a gaze of a user. The system may determine the size (e.g., length and width) of ROI 502 based on an area that a person can focus on. For example, a person may be able to distinguish high-resolution image data in ROI 502 from lower-resolution image data. Accordingly, it may be important, for foveated imaging, to render ROI 502 with a high resolution.

However, because a user's gaze may change between when gaze center 510 is determined and when an image sensor can capture foveated image 500 with a high resolution in ROI 502 and a lower resolution in peripheral region 506, a system may cause an image sensor to capture image data of ROI 504 at the high resolution. ROI 504 may be larger than ROI 502 (e.g., by margin 512 and margin 514). Capturing the image data of ROI 504 at the high resolution may improve a user's experience with foveated imaging because even if the user's gaze moves, the user's gaze will be within the ROI 504 and the user will see high resolution image data in the area where the user can focus their eyes.

However, capturing and processing image data of ROI 504 at a high resolution, rather than capturing and processing image data of ROI 502 at the high resolution may consume more computational resources than capturing and processing image data of ROI 502 at a high resolution and capturing and processing image data of ROI 504 at a lower resolution. In other words, expanding the size of ROI 502 by margin 512 and margin 514 to arrive at ROI 504 to account for a delay in registering the ROI with the image sensor may decrease some of the computational-resource conservation of foveated imaging.

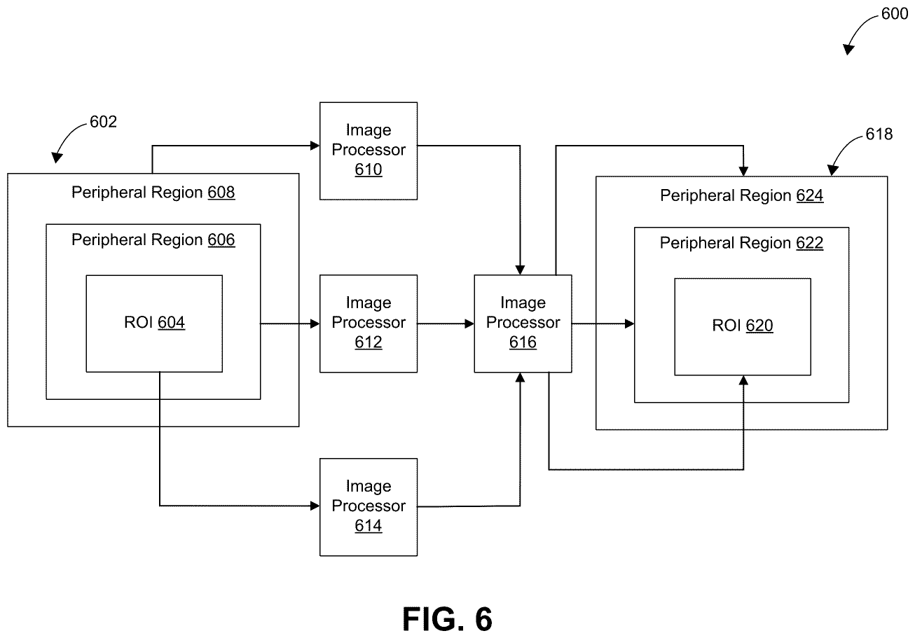

FIG. 6 is a block diagram illustrating an example system 600 for processing foveated image data, according to various aspects of the present disclosure. For example, system 600 may obtain foveated image data 602, which includes a ROI 604, a peripheral region 606, and a peripheral region 608. ROI 604 may include pixel data (e.g., red-green-blue (RGB) data or luma, blue projection, red projection (YUV) data) arranged in ROI 604 at a first resolution. Peripheral region 606 may include pixel data arranged in peripheral region 606 at a second resolution. Peripheral region 608 may include pixel data arranged in peripheral region 608 at a third resolution. The first resolution may be greater than the second resolution, which may be greater than the third resolution.

Peripheral region 608 may include pixels (at the third resolution) for the full frame of foveated image data 602. As such, peripheral region 608 may include pixels (at the third resolution) overlapping peripheral region 606 and ROI 604. Similarly, peripheral region 606 may include pixels (at the second resolution) for the full area of peripheral region 606. As such, peripheral region 606 may include pixels (at the second resolution) overlapping ROI 604.

System 600 may obtain foveated image data 602 from a foveated-image sensor (e.g., an image sensor configured to generate foveated image data). The foveated image sensor may receive an indication of ROI 604 and capture foveated image data 602 with different resolutions at ROI 604, peripheral region 606, and peripheral region 608 based on the received indication of ROI 604. The foveated-image sensor may store foveated image data 602 in a memory (e.g., a random-access memory (RAM), such as a double-data-rate RAM (DDR RAM)) and system 600 may read foveated image data 602 from the memory.

System 600 may include an image processor 610, an image processor 612 and an image processor 612. Image processor 610 may process peripheral region 608, image processor 612 may process peripheral region 606, and image processor 614 may process ROI 604. Image processor 610, image processor 612, and image processor 614 may be regions of an image processor. For example, image processor 610, image processor 612, and image processor 614 may be respective regions of an image-processing engine (IPE). Alternatively, each of image processor 610, image processor 612, and image processor 614 may be a separate respective image processor (e.g., an IPE). Image processor 610, image processor 612, and image processor 614 may perform operations related to, for example, spatial/temporal noise processing, and/or tone mapping.

System 600 is illustrated with foveated image data 602 including one ROI and two peripheral regions and three corresponding image processors (image processor 610, image processor 612, and image processor 614) for illustrative purposes. In other cases, system 600 may include any number of image processors and foveated image data 602 may include any number of ROIs and/or peripheral regions.

System 600 may include an image processor 616 that may process processed outputs of image processor 610, image processor 612, and image processor 614. Image processor 616 may be, or may include, a graphics-processing unit (GPU). Image processor 616 may process the outputs of image processor 610, image processor 612, and image processor 614 to generate foveated image data 618. Image processor 616 may perform operations related to, for example, plane blending, alignment, and/or virtual-object rendering.

Foveated image data 618 may include a ROI 620, a peripheral region 622, and a peripheral region 624. ROI 620 may include pixel data arranged in ROI 620 at a first resolution. Peripheral region 622 may include pixel data arranged in peripheral region 622 at a second resolution. Peripheral region 624 may include pixel data arranged in peripheral region 624 at a third resolution. The first resolution may be greater than the second resolution, which may be greater than the third resolution.

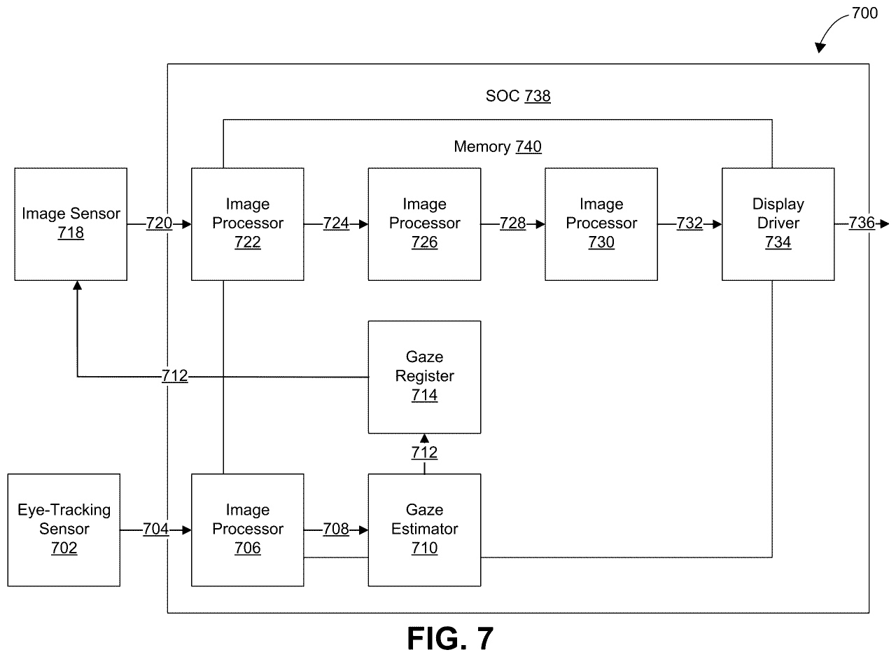

FIG. 7 is a block diagram illustrating an example system 700 for processing foveated image data, according to various aspects of the present disclosure. An eye-tracking sensor 702 may capture facial images 704. For example, eye-tracking sensor 702 may be, or may include, one or more cameras facing a user of a device (e.g., an HMD). Facial images 704 may include images of at least a portion of the face of a user, including one or both eyes of the user.

An image processor 706 may process facial images 704 to generate facial images 708. Image processor 706 may perform such tasks as noise processing on facial images 704.

A gaze estimator 710 may determine ROI 712 based on facial images 708. For example, gaze estimator 710 may determine a position within an image frame at which the user is looking. For example, gaze estimator 710 may translate a position of eyes of the user in facial images 704 into a position within an image frame of an image being displayed to the user.

In some aspects, gaze estimator 710 may predict a future gaze of the user. For example, in addition to determining where the user is currently looking, gaze estimator 710 may predict where the user will look at a future time based on facial images 708. In some aspects, gaze estimator 710 may determine or predict the gaze according to a series-prediction technique. In other aspects, gaze estimator 710 may determine or predict the gaze using a machine-learning model trained to predict a gaze. As such, ROI 712 may be based on a predicted gaze of the user. ROI 712 may represent an indication of an ROI (e.g., pixel coordinates of the ROI within an image frame).

In some aspects, gaze estimator 710 may determine ROI 712 with margins (e.g., margin 512 and/or margin 514) as described with regard to FIG. 5.

Gaze register 714 may cause image sensor 718 to capture foveated image data based on ROI 712. For example, gaze register 714 may store an indication of ROI 712 in a register accessible by image sensor 718 such that image sensor 718 captures foveated image data 720 based on ROI 712.

Image sensor 718 may be, or may include, an image sensor configurable to capture foveated image data. For example, image sensor 718 may be configurable to capture image data with various resolutions in various respective regions (e.g., as described with regard to foveated image 500 of FIG. 5).

Image sensor 718 may capture foveated image data 720 based on ROI 712. For example, image sensor 718 may capture foveated image data 720 such that foveated image data 720 has a highest resolution in ROI 712 and one or more lower resolutions in one or more peripheral regions. foveated image data 720 may be an example of foveated image 400 of FIG. 4, foveated image 500 of FIG. 5, or foveated image data 602 of FIG. 6.

Image processor 722 may process foveated image data 720 to generate foveated image data 724. Image processor 722 may perform operations related to, for example, Bayer processing, statistics collection, noise processing, and/or pixel corrections on foveated image data 720 to generate foveated image data 724.

Image processor 722 may be, or may include, an image front-end (IFE) image processor. For example, image processor 722 may obtain foveated image data 720 directly from image sensor 718. After processing foveated image data 720, image processor 722 may store foveated image data 724 in a memory 740 (e.g., a RAM, such as a DDR RAM). Image processor 726 may obtain (e.g., receive, fetch or retrieve, etc.) foveated image data 724 from memory 740. In contrast, image processor 722 may obtain foveated image data 720 at an interface (e.g., a bus or other interface) between image sensor 718 and image processor 722.

Image processor 726 may be an example of image processor 610, image processor 612, and image processor 614 of FIG. 6. Image processor 726 may be an image-processing engine (IPE). Image processor 726 may process foveated image data 724 to generate foveated image data 728. Image processor 726 may store foveated image data 728 in memory 740. Image processor 726 may perform operations related to, for example, spatial/temporal noise processing, and/or tone mapping.

Image processor 730 may be an example of image processor 616 of FIG. 6. Image processor 730 may be a graphics processing unit (GPU). Image processor 730 may read foveated image data 728 from memory 740, process foveated image data 728 to generate foveated image data 732, and store foveated image data 732 in memory 740. Image processor 730 may perform operations related to, for example, plane blending, alignment, and/or virtual-object rendering.

Display driver 734 may read foveated image data 732 from memory 740 and condition foveated image data 732 to generate foveated image data 736 and provide foveated image data 736 to a display such that the display displays foveated image data 736.

Image processor 706, gaze estimator 710, gaze register 714, image processor 722, image processor 726, image processor 730, and/or display driver 734 may be implemented on a system-on-a-chip (SOC) 738. SOC 738 may enable relatively quick communications between image processor 706, gaze estimator 710, gaze register 714, image processor 722, image processor 726, image processor 730, and/or display driver 734. For example, SOC 738 may enable image processor 706, gaze estimator 710, gaze register 714, image processor 722, image processor 726, image processor 730, and/or display driver 734 to write data to, and read data from, memory 740 relatively quickly. For example, communications between gaze register 714 and image processor 722 may be faster than communications between gaze register 714 and image sensor 718.

There may be latency (e.g., a delay) in gaze register 714 registering ROI 712 with image sensor 718. For example, if image sensor 718 capturing foveated image data 720 repeatedly, for example, at a rate, such as 30 frames per second (fps), there may be a delay that equates to the time to capture several frames between when ROI 712 is determined and when image sensor 718 is able to capture frames according to ROI 712. Accordingly, if a gaze of a user changes over time, foveation at image sensor 718 may lag behind the user's gaze based on the latency of registering ROI 712 with image sensor 718.

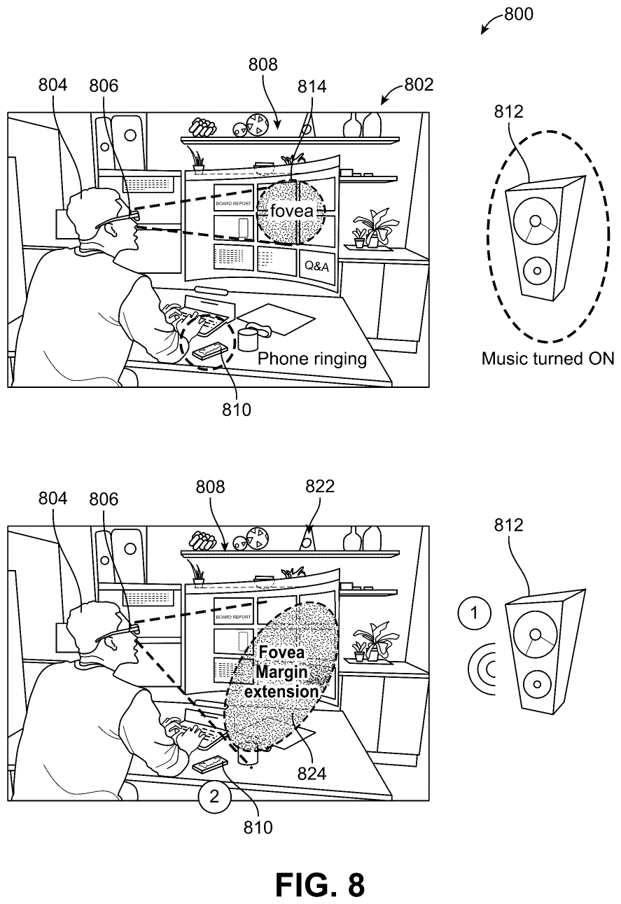

FIG. 8 is a diagram illustrating an example scenario 800 in which an XR device 806 may determine a ROI 824 and/or capture, process, render, and/or display image data based on ROI 824 according to various aspects of the present disclosure. For example, XR device 806 may use audio data to understand events in environment 808 to predict the gaze of user 804. Additionally, by predicting the gaze of user 804 based on audio data, allows XR device 806 to predict where a gaze change will stop (e.g., where head and/or eye motion will stop), thereby giving XR device 806 an understanding of the extent of motion (e.g., head movement, which may be referred to as global motion and/or eye motion). XR device 806 may also use audio data also to improve the scene capture by determining a capture rate, resolution, bit-depth etc. to improve power and bandwidth usage.

Prior to time 802, XR device 806 may determine ROI 814 based on a gaze of user 804. Accordingly, XR device 806 may capture, process, render, and/or display image data in ROI 814 at a relatively high resolution and image data in regions around ROI 814 at lower resolutions. For example, XR device 806 may capture, process, render, and/or display foveated image data based on ROI 814.

At time 802, phone 810 may ring. In some aspects, XR device 806 may determine a position of phone 810 in environment 808. For example, XR device 806 may include multiple microphones (e.g., microphones 204) and use sound from phone 810 to determine (e.g., according to a time-difference-of-arrival (TDOA) technique) the position of phone 810.

Additionally or alternatively, XR device 806 may determine a direction between a center of an FOV of XR device 806 and phone 810. For example, XR device 806 may determine an angle of arrival of sound from phone 810 (e.g., according to a TDOA technique).

XR device 806 may determine that user 804 is likely to look at phone 810. Accordingly, at time 822, XR device 806 may determine ROI 824. For example, XR device 806 may adjust ROI 814, for instance by extending ROI 814 in the direction of phone 810. ROI 814 and/or ROI 824 may have any shape, such as rectangular, elliptical, irregular, etc. In extending ROI 814 toward phone 810, XR device 806 may extend or enlarge margins of ROI 814 toward phone 810 (e.g., margins as described with regard to margin 512 and margin 514 of FIG. 5).

Having determined ROI 824, XR device 806 may capture, process, render, and/or display image data in ROI 824 at a relatively high resolution and image data in regions around ROI 824 at lower resolutions. For example, XR device 806 may capture, process, render and/or display foveated image data based on ROI 824.

Further, at time 802, speaker 812 may begin to play sound. In some aspects, XR device 806 may determine that user 804 is more likely to look at phone 810 than at speaker 812. In some aspects, XR device 806 may determine that XR device 806 is more likely to look at phone 810 than at speaker 812 based on a classification of a sound output by phone 810 and a classification of a sound output by speaker 812. For example, XR device 806 may implement a sound classifier (e.g., a machine-learning model trained to classify sounds). XR device 806 may classify a sound output by phone 810 and a sound output by speaker 812. XR device 806 may determine which of phone 810 or speaker 812 user 804 is more likely to look at based on the classification of the sounds output by phone 810 and speaker 812. For example, XR device 806 may determine that user 804 is more likely to look at a ringing phone than at a speaker that is playing music. Accordingly, XR device 806 may determine to extend ROI 824 toward phone 810 and not toward speaker 812. In other cases, XR device 806 may determine to extend ROI 814 toward both phone 810 and speaker 812 (e.g., based on likelihoods that user 804 may look at phone 810 and/or speaker 812).

In some cases, XR device 806 may track which classes of sounds (or objects in environment 808) user 804 responds to. For example, XR device 806 may track instances in which phone 810 makes sound and whether user 804 looks at phone 810 in response to the sounds. Similarly, XR device 806 may track instances in which speaker 812 makes sound and whether user 804 looks at speaker 812 in response to the sounds. Over several tracked responses, XR device 806 may learn which classes of sounds, types of objects, particular objects, and/or particular sounds are user 804 is likely to respond to. Accordingly, XR device 806 may determine a likelihood of user 804 looking at various objects based on the tracked responses.

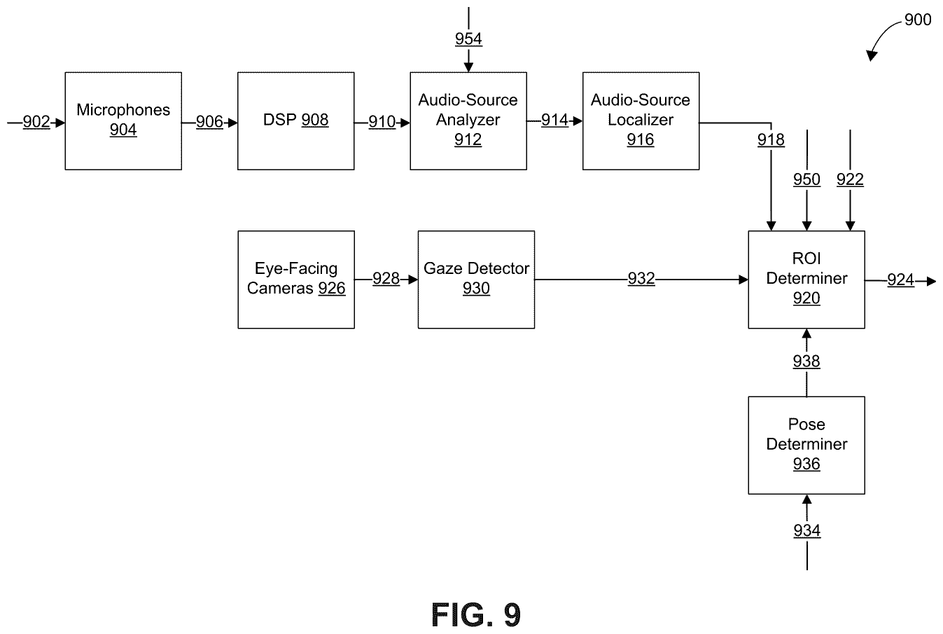

FIG. 9 is a block diagram illustrating an example system 900 for determining ROI 924 based on sound 902, according to various aspects of the present disclosure. For example, XR device 806 of FIG. 8 may implement system 900 of FIG. 9 to determine ROI 824.

Microphones 904 may receive sound 902 and generate audio signals 906 based on sound 902. Sound 902 may be sound in an environment (e.g., pressure waves propagating through the air of the environment). Microphones 904 may include transducers that may translate the sound into audio signals 906. Audio signals 906 may be electrical signals generated based by microphones 904 based on sound 902. Microphones 904 may include two or more microphones positioned on the device that implements system 900 (e.g., an XR HMD such as XR device 806). Microphones 904 may be positioned such that sound 902 may arrive at different ones of microphones 904 at different times. In some aspects, microphones 904 may include an array of microphones.

Digital signal processor (DSP) 908 may process audio signals 906 to generate processed audio signals 910. For example, DSP 908 may filter out ambient noise and/or detect abrupt changes in audio signals 906 using Audio DSP techniques.

Audio-source analyzer 912 may analyze processed audio signals 910 to generate audio information 914. For example, audio-source analyzer 912 may perform audio-source segmentation. For instance, audio-source analyzer 912 may segment audio data from various microphones based on sources of sounds. For example, audio-source analyzer 912 may identify audio data that is based on sounds produced by phone 810 from audio data that is based on sounds produced by speaker 812.

Additionally or alternatively, audio-source analyzer 912 may classify the segmented audio data (e.g., classify audio data from phone 810 and classify audio data from speaker 812). Further, audio-source analyzer 912 may determine priorities associated with the classified segments of audio data. For example, audio-source analyzer 912 may determine likelihoods that a user of system 900 will react to various sounds. For instance, audio-source analyzer 912 may determine a likelihood that user 804 will turn toward to sound produced by phone 810 and/or a likelihood that user 804 will turn toward sound produced by speaker 812.

In some aspects, audio-source analyzer 912 may determine the likelihood that a user will react to audio data based on priority data 954. Priority data 954 may be, or may include, learned priorities of a particular user (e.g., based on prior behavior of the particular user). For example, a personalizer may track whether a user reacts to certain classes of sounds and determine priority data 954 based on how often a user reacts to certain classes of sounds. Audio-source analyzer 912 may relate the classes of sounds to which the user frequently reacts (as indicated by priority data 954) with the classes of audio data of processed audio signals 910 to determine to which sounds the user is likely to react. Additionally or alternatively, audio-source analyzer 912 may determine which sounds a user is likely to react to in the presence of multiple sources of sound. For example, audio-source analyzer 912 may determine that a user is more likely to gaze toward a ringing phone than a doorbell based on priority data 954.

Audio information 914 may be, or may include, segmented and/or classified audio data. Additionally, audio information 914 may include likelihoods of a user reacting (e.g., looking toward or at) the various audio segments.

Audio-source localizer 916 may generate sound-source location information 918 based on audio information 914. Audio-source localizer 916 may determine a location or direction related to sources of the sounds sound 902. For example, audio-source localizer 916 may perform TDOA based on sound 902 as received by various ones of microphones 904 to determine a direction between a center of a FOV of a device and the various sources of sound 902. Further, in some aspects, audio-source localizer 916 may perform TDOA based on sound 902 to determine a location of the various sources of sound 902. In some aspects, audio-source localizer 916 may determine a direction or location for the highest priority sound (e.g., the sound to which the user is most likely to react).

Sound-source location information 918 may be, or may include, location and/or direction information for one or more sources of sound 902. For example, sound-source location information 918 may include a direction (relative to a FOV of a device) between a center of an FOV of the device and the source of the highest-priority sound.

Additionally, eye-facing cameras 926 may capture facial images 928. Eye-facing cameras 926 may be, or may include, one or more cameras positioned and directed to capture images of eyes of a user of the device that implements system 900 (e.g., an XR HMD). Eye-facing cameras 926 may be the same as, may be substantially similar to, and/or may perform the same, or substantially the same, operations as eye-tracking sensor 702 of FIG. 7. Facial images 928 may be, or may include, images including eyes of the user. Facial images 928 may be the same as, or may be substantially similar to, facial images 704 of FIG. 7.

Gaze detector 930 may generate gaze information 932 based on facial images 928. For example, gaze detector 930 may determine a center of a current gaze of the user. Additionally or alternatively, gaze detector 930 may predict a gaze of the user. Gaze detector 930 may be the same as, may be substantially similar to, and/or may perform the same, or substantially the same, operations as gaze estimator 710 of FIG. 7. Gaze information 932 may indicate the center of the gaze of the user.

Additionally, pose determiner 936 may determine pose information 938, which may include a pose (and in some cases, velocity) of the device that implements system 900. For example, one or more IMUs (which may include one or more gyroscopes, accelerometers, and/or accelerometers) may generate inertial data and provide the inertial data to pose determiner 936 as pose data 934. Pose determiner 936 may determine the pose and/or velocity of the device based on the inertial data. Additionally or alternatively, pose determiner 936 may obtain image data (e.g., as pose data 934) and use computational geometry techniques, such as visual simultaneous localization and mapping (VSLAM) to determine the pose and/or velocity of the device.

ROI determiner 920 may determine ROI 924 based on sound-source location information 918, gaze information 932 and pose information 938. For example, ROI determiner 920 may determine ROI 924 based on a current and/or predicted gaze of the user based on gaze information 932. Further, ROI determiner 920 may determine ROI 924 based on how the device is moving (e.g., such that ROI 924 can track points in the environment as the device moves).

ROI determiner 920 may determine ROI 924 based on a probability that the user will look toward a sound source as indicated by sound-source location information 918. For example, ROI determiner 920 may extend an ROI in a direction based on a prediction that the user will look toward a sound in the direction. The prediction that the user will look toward a sound in the direction may be based on the probability that the user will look toward the sound source exceeding a threshold. For example, ROI determiner 920 may determine ROI 824 based on a prediction that user 804 will look toward phone 810.

ROI determiner 920 may determine ROI 924 based on or relative to scene-image data 922. For example, a scene-facing camera may capture scene-image data 922. ROI determiner 920 may determine ROI 924 relative to scene-image data 922.

In some aspects, ROI determiner 920 may determine ROI 924 based on margin data 950. Margin data 950 may be, or may include, indications of margin sizes. For example, margin data 950 may indicate a default size and/or shape of an ROI. For instance, margin data 950 may include an indication of margin 512 and/or margin 514 of FIG. 5.

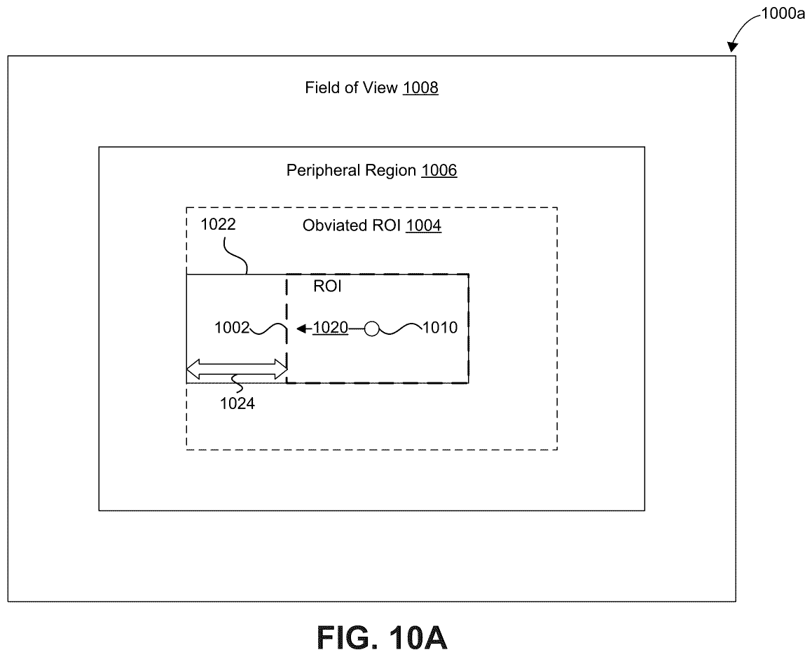

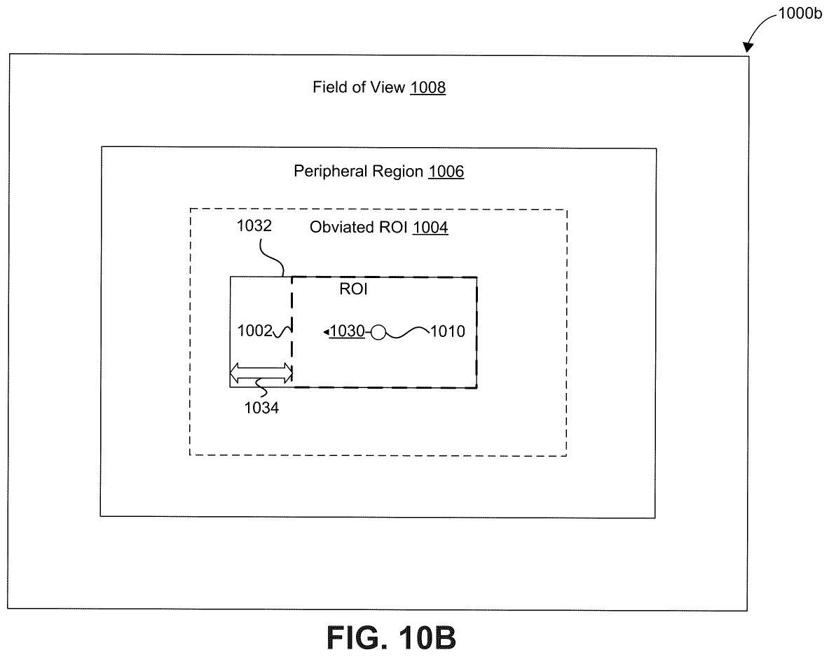

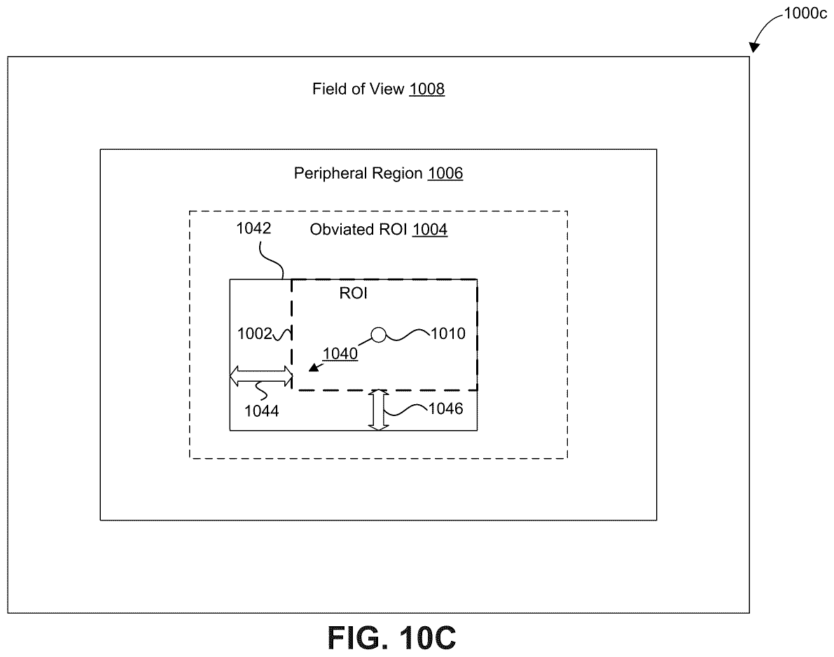

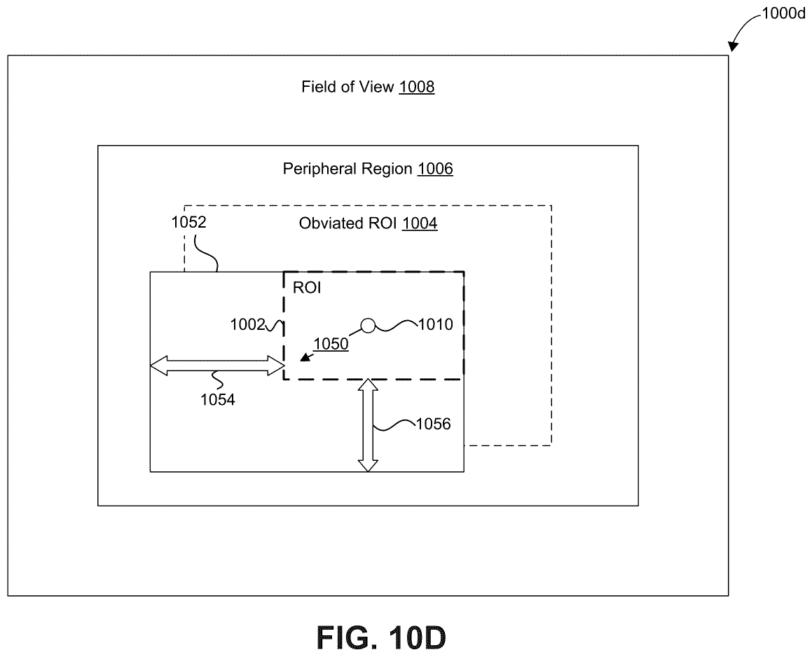

FIG. 10A includes an example foveated image 1000a including a ROI 1022 determined according to various aspects of the present disclosure. For instance, gaze center 1010 represents a center of a current (or predicted) gaze of a user. Techniques that may determine an ROI based on gaze only may determine obviated ROI 1002 (e.g., a shape, such as a rectangle, centered on gaze center 1010). Additionally, foveated image 1000a includes a peripheral region 1006 and a field of view 1008. Additionally, to compensate for inaccuracies, such techniques may determine an obviated ROI 1004 around obviated ROI 1002.

In contrast, ROI determiner 920 may determine ROI 1022 based on sound-source location information 918. For instance, ROI determiner 920 may determine ROI 1022 (which extends to the left) based on a prediction that a user may look to the left at a sound source that is to the left of gaze center 1010. Stated another way, ROI determiner 920 may determine margin 1024 to extend obviated ROI 1002 to the left based on a prediction 1020 that the user will look at a sound source that is to the left of gaze center 1010.

The area between ROI 1022 and obviated ROI 1004 represents a savings based on using audio information to determine ROI 1022. For example, techniques that use only gaze information to determine an ROI may determine to use high-resolution image data of obviated ROI 1004. In contrast, ROI determiner 920 may determine to use ROI 1022 which may reduce the size of the area for which high-resolution image data is captured, processed, rendered, and/or displayed. Such a reduction may conserve power and/or bandwidth.

There is a correlation between head motion and gaze direction. Therefore, ROI determiner 920 adjust ROI 1022 such that the margins (e.g., margin 1024) are programmed only in the direction of motion (and/or the direction of the sound source) and margins in other directions are pruned.

Over time, head speed in response to different sound types can also be learned. Accordingly, the margins (e.g., the size of margin 1024) may be adjusted based on the learned speed of head motion and/or gaze change. For example, for a slow-moving head, ROI determiner 920 can further reduce the margins in the direction of motion providing more savings.

For example, FIG. 10B illustrates a case in which ROI 1032 is extended by margin 1034 based on a prediction 1030. ROI 1032 is smaller than ROI 1022 based on prediction 1030 being smaller than prediction 1020. For example, based on a prediction that a gaze of a user will move more slowly in the case of FIG. 10B than in the case of FIG. 10A. The difference in the size of ROI 1032 and ROI 1022 may result in conservation of image data to capture, process, render, and/or display.

Notably, FIG. 10A includes an example foveated image 1000a and FIG. 10B includes an example foveated image 1000b. Foveated image 1000a and/or foveated image 1000b may be images of respective series of foveated images that may be captured, processed, rendered, and/or displayed over time. For example, foveated image 1000a may relate to a case in which user 804 is predicted to quickly move their gaze to focus on phone 810. Foveated image 1000b may relate to a case in which user 804 is predicted to slowly move their gaze to focus on phone 810. In this example, the destination of the gaze (e.g., where the gaze is predicted to rest) may be the same, but the speed at which the gaze is predicted to reach the destination is different between foveated image 1000a and foveated image 1000b.

Additionally, ROI determiner 920 may differentiate between predicted head motion and predicted gaze change. For example, ROI determiner 920 may predict whether a user will turn their head to look at a sound source or whether the use will change the eye angle without turning their head to look at the sound source. For example, based on a distance (e.g., angular or in image space) between gaze center 1010 and a point associated with the sound source, ROI determiner 920 may predict whether the user will turn their head to look at the sound source or whether the user will turn their eyes, without turning their head to look at the sound source. Further, ROI determiner 920 may determine ROI 924 based on whether the user is predicted to turn their head or adjust their eye angle.

In case of head motion, there is less relative movement of an ROI. For example, as the head moves, the FOV moves. Thus, the relative position of the ROI within the FOV may move less when a head moves than when eyes move without the head moving. Hence, ROI determiner 920 may use smaller margins when head motion is likely to happen than when eye motion without head motion is likely.

Gaze change is more likely when an object at which the user is predicted to gaze is 30 degrees or less from the of the user's FOV (which may correspond to a scene-facing camera's FOV). Therefore, if the location of sound source is within 30 degrees of center of field of view 1008, the user is likely to shift their gaze rather than move their heads. Based on this distinction between only gaze motion and head and gaze motion, ROI determiner 920 can determine smaller margins in the direction of motion when it is determined that the audio source is far away from the gaze point (e.g., based on a prediction that they user will turn their heads).

For example, FIG. 10C illustrates a case in which ROI 1042 is extended by margin 1044 and margin 1046 based on a prediction 1040. In contrast, FIG. 10D illustrates a case in which ROI 1052 is extended by margin 1054 and margin 1056 based on a prediction 1050.

ROI determiner 920 may determine ROI 1042 based on a prediction that the user will turn their head to look at a sound source. ROI determiner 920 may determine ROI 1052 based on a prediction that the user will adjust their gaze, without moving their head, to look at the sound source.

Prediction 1040 and prediction 1050 may have the same direction and magnitude. Yet, ROI 1052 may be larger than ROI 1042 based on the prediction regarding head movement. For example, prediction 1040 and prediction 1050 may correlate to a prediction of the user looking at or toward the same location in the time related to foveated image 1000c and foveated image 1000d. For instance, FIG. 10C includes an example foveated image 1000c and FIG. 10D in includes an example foveated image 1000d. Foveated image 1000c and/or foveated image 1000d may be images of respective series of foveated images that may be captured, processed, rendered, and/or displayed over time. The ultimate destination of the gaze of the user in the case of FIG. 10C may be farther away from a center of field of view 1008 than the ultimate destination of the gaze of the user in the case of FIG. 10D is from the center of field of view 1008. Further, based on the ultimate destination of the gaze of the user in the case of FIG. 10C being outside a 30-degree angle from the center of field of view 1008, ROI determiner 920 may determine that the user may turn their head to gaze at the sound source. However, based on the ultimate destination of the gaze of the user in the case of FIG. 10D being inside a 30-degree angle from the center of field of view 1008, ROI determiner 920 may determine that the user will look toward the ultimate destination without turning their head. Accordingly, ROI determiner 920 may generate ROI 1042 based on smaller margins (e.g., margin 1044 and margin 1046) than ROI determiner 920 uses to generate for the case of FIG. 10D.

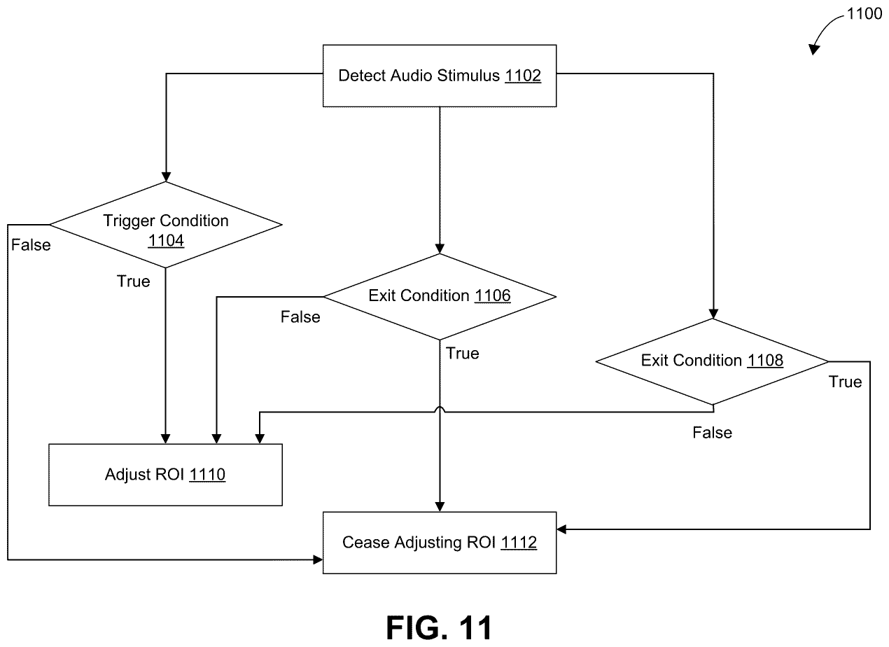

FIG. 11 is a flow diagram illustrating an example process 1100 that may be used in determining an ROI according to various aspects of the present disclosure. At block 1102, an audio stimulus may be detected. For example, a sound 902 may be captured by microphones 904. The audio stimulus may start suddenly, in other words, the audio stimulus may be abrupt. The detection of the audio stimulus may be associated with a time “t.” A duration “Δt” may be a duration since time “t.”

At decision block 1104, it may be determined whether Δt is greater than “t1.” “t1” may be a predetermine duration of time to wait after detection of audio stimulus before ROI determiner 920 begins doing a margin adjustment. If Δt >t1, process 1100 may proceed to block 1110. If Δt≤t1, process 1100 may proceed to block 1112.

At decision block 1106, it may be determined whether Δt is greater than “t2.” “t2” may be a predetermine duration of time after which ROI determiner 920 may determine that the user will not react to the audio stimulus. If Δt>t2, process 1100 may proceed to block 1112. If Δt≤t1, process 1100 may proceed to block 1110.

At decision block 1108, it may be determined whether the user has the source of the audio stimulus in their gaze. If the user is gazing at the source of the audio stimulus, the process 1100 may proceed to block 1112. If the user is not yet gazing at the source of the audio stimulus, process 1100 may proceed to block 1110.

At block 1110, an ROI may be determined or adjusted. For example, ROI determiner 920 may adjust margins of an ROI. At block 1112, ROI determiner 920 may cease adjusting the ROI.

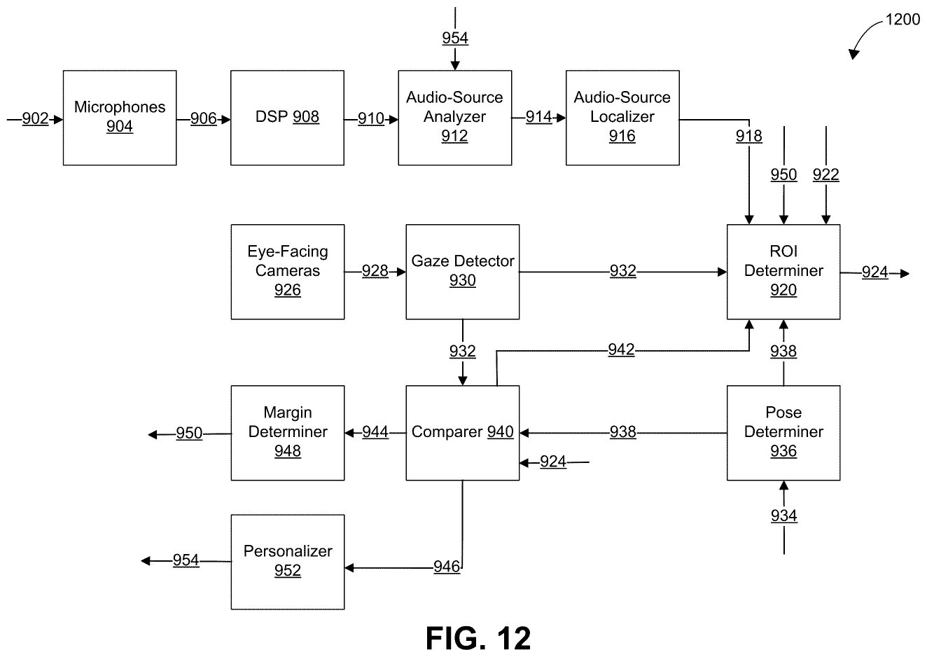

FIG. 12 is a block diagram of an example system 1200 that may determine ROI 924 according to various aspects of the present disclosure. System 1200 may include system 900 of FIG. 9.

Additionally, system 1200 may include a comparer 940. Comparer 940 may implement a feedback loop with ROI determiner 920 based on a comparison between a predicted gaze (e.g., ROI 924) and an observed gaze (e.g., based on gaze information 932 and pose information 938). For example, ROI determiner 920 may adjust ROI 924 based on gaze information 932 and sound-source location information 918. For example, based on sound-source location information 918, ROI determiner 920 may predict that a user will gaze at the source of sound 902 and adjust ROI 924 to be toward the source of sound 902. Pose determiner 936 may track the pose of the device implementing system 1200. Gaze detector 930 may track a gaze of the user. Comparer 940 may determine whether the user gazes (and/or turns their head) toward the source of sound 902). If the user does not shift their gaze (and/or move their head) toward the source of sound 902, comparer 940 may provide feedback 942 indicating such and ROI determiner 920 may determine to cease adjusting ROI 924 based on sound-source location information 918 (e.g., as described with regard to FIG. 11). However, if the user does shift their gaze (and/or move their head) toward the source of sound 902, comparer 940 may provide feedback 942 indicating such and ROI determiner 920 may continue to adjust ROI 924 based on sound-source location information 918 (e.g., as described with regard to FIG. 11).

Additionally or alternatively, comparer 940 may determine accuracy data 944. Comparer 940 may provide accuracy data 944 to margin determiner 948. Accuracy data 944 may indicate a long-term accuracy of ROI determiner 920 in for head motion and/or gaze change. For example, if predicted head motion/gaze change matches with the actual pose/gaze change, the accuracy of system 1200 is high. Over time as the accuracy increases, margin determiner 948 may program lower margins even for steady state cases (no head motion/gaze change cases).

Margin determiner 948 may determine margin data 950 based on accuracy data 944. If the distance between the gaze center and the center of the ROI is consistently (e.g., over time) small (e.g., smaller than current margins), margin determiner 948 may decrease margins (e.g., decreasing margin 512 and/or margin 514). If the distance between the gaze center and the center of the ROI is consistently (e.g., over time) large (e.g., larger than or about the same size as the current margins), margin determiner 948 may increase margins (e.g., increasing margin 512 and/or margin 514). Margin data 950 may include instructions regarding the sizes of margins. Margin determiner 948 may provide margin data 950 to ROI determiner 920 and ROI determiner 920 may determine ROI 924 based on margin data 950.

The feedback loop including comparer 940, margin determiner 948, and ROI determiner 920 may operate to reduce the size of ROI 924 with or without sound-source location information 918. For example, whether or not audio-source localizer 916 predicts that the user will look at a sound source, comparer 940, margin determiner 948, and ROI determiner 920 may operate to reduce the size of ROI 924. For example, even in the absence of microphones 904, DSP 908, audio-source analyzer 912, and audio-source localizer 916, the feedback loop including comparer 940, margin determiner 948, and ROI determiner 920 may reduce the size of ROI 924 based on whether the user is consistently looking at the ROI as determined based on gaze information 932. Additionally or alternatively, there could be other bases for predicting a gaze of a user. The other bases may further strengthen head motion/gaze change prediction. When the head motion/gaze change prediction accuracy is high enough, the feedback loop including comparer 940, margin determiner 948 can reduce margins in the no-gaze-change/head-movement cases (e.g., steady-state cases) leading to even more average savings. Margins in these cases can be determined using a look up table based on current prediction accuracy. If prediction accuracy is high, lower the margins.

Additionally or alternatively, comparer 940 may determine response data 946 and provide response data 946 to personalizer 952. Response data 946 may indicate a response of a user to sound 902. In some aspects, audio-source analyzer 912 may classify sound 902 and personalizer 952 may track the response of the user to various classes of sounds. Personalizer 952 may determine priority data 954 to include indications of the responses of the user to various classes of sounds. For example, priority data 954 may indicate that the user has looked (in many past instances) at a person speaking but not at a dog barking. Audio-source analyzer 912 may determine a likelihood of the user to look at a particular sound source based on priority data 954. Over time, personalizer 952 may “learn” priorities of the user (e.g., classes of sound sources the user is likely to look at).

As described with regard to system 700 of FIG. 7, once ROI determiner 920 determines ROI 924, a gaze register (e.g., gaze register 714) may register ROI 924 with an image sensor (e.g., image sensor 718). By registering ROI 924 with an image sensor, an imaging pipeline (e.g., including image sensor 718, image processor 722, image processor 726, image processor 730, and display driver 734) may all benefit by processing foveated image data.

Additionally, as described with regard to system 700 of FIG. 7, there may be a latency in registering ROI 924 with the image sensor. Thus, rather than registering ROI 924 with the image sensor (e.g., image sensor 718), according to various aspects of the present disclosure, ROI determiner 920 may register ROI 924 with one or more image processors of the image-processing pipeline.

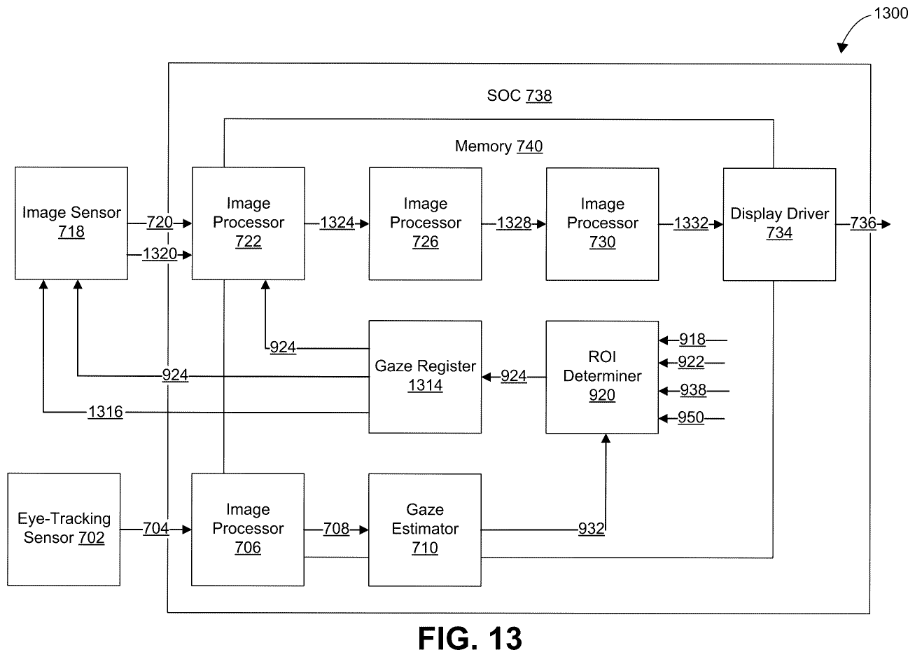

For example, FIG. 13 includes a block diagram of an example system 1300, that may capture, process, render, and/or display foveated image data, according to various aspects of the present disclosure. System 1300 may include the elements of system 700 of FIG. 7. Additionally, system 1300 may include ROI determiner 920 of FIG. 9.

In system 1300, gaze estimator 710 may the same as, may be substantially similar to, and/or may perform the same, or substantially the same, operations as gaze detector 930 of FIG. 9. For example, gaze estimator 710 may generate gaze information 932 based on facial images 708.

ROI determiner 920 may generate ROI 924 based on gaze information 932, sound-source location information 918, scene-image data 922, pose information 938, and margin data 950. ROI determiner 920 may provide ROI 924 to gaze register 1314.

Gaze register 1314 may be substantially similar to gaze register 714 of FIG. 7. For example, gaze register 1314 may register ROI 924 with image sensor 718. Additionally, gaze register 1314 may register ROI 924 with image processor 722. However, based on a delay in registering ROI 924 with image sensor 718, gaze register 1314 may register a gaze-based ROI 1316 (e.g., with increased margins) with image sensor 718 and image sensor 718 may provide previously-captured foveated image data 1320 to image processor 722 at about the time image processor 722 receives ROI 924 from gaze register 1314.

System 1300 may conserve conservational resources as compared with system 700 by providing image processor 722 with an indication of ROI 924 such that image processor 722 may process previously-captured foveated image data 1320 based on ROI 924 and further so that image processor 726, image processor 730, and/or display driver 734 may respectively process foveated image data 1324, foveated image data 1328, and foveated image data 1332 based on ROI 924.

Image processor 722 may obtain previously-captured foveated image data 1320 which may include an ROI sized based on previously-determine ROI 1316 (e. g, based on a delay of registering ROI 924 with image sensor 718). Image processor 722 may generate foveated image data 1324 such that foveated image data 1324 has an ROI sized based on ROI 924. Thus, foveated image data 1324 may be smaller than previously-captured foveated image data 1320. Additionally or alternatively, as the long-term accuracy of 1300 increases, a margin determiner (e.g., margin determiner 948) can determine lower margins to the ROI given to sensor which will also save bandwidth/power consumption over the PHY link between sensor and ISP. Thus, image processor 722 may consume less computational resources when processing previously-captured foveated image data 1320 (e.g., according to system 1300) than when processing foveated image data 720 (e.g., according to system 700). Similarly, image processor 726 may consume less computational resources when processing foveated image data 1324 (e.g., according to system 1300) than when processing foveated image data 724 (e.g., according to system 700). Similarly, image processor 730 may consume less computational resources when processing foveated image data 1328 (e.g., according to system 1300) than when processing foveated image data 728 (e.g., according to system 700). Further, display driver 734 may consume less computational resources when processing foveated image data 1332 (e.g., according to system 1300) than when processing foveated image data 732 (e.g., according to system 700).

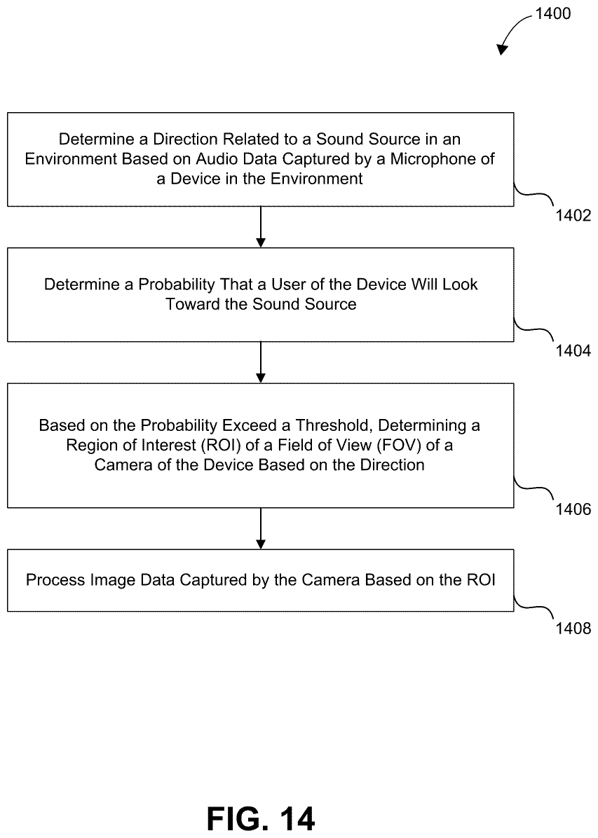

FIG. 14 is a flow diagram illustrating an example process 1400 for determining an ROI, in accordance with aspects of the present disclosure. One or more operations of process 1400 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1400. The one or more operations of process 1400 may be implemented as software components that are executed and run on one or more processors.

At block 1402, a computing device (or one or more components thereof) may determine a direction related to a sound source in an environment based on audio data captured by a microphone of a device in the environment. For example, XR device 806 may determine a direction between a center of a FOV of XR device 806 and phone 810.

In some aspects, to determine the direction related to the sound source, the computing device (or one or more components thereof) may: estimate an angle of arrival of sound from the sound source based on the audio data, wherein the angle of arrival is relative to a pose of the device; and determine the direction based on the estimated angle of arrival of the sound source. For example, XR device 806 may estimate an angle of arrival of sound from phone 810. The angle of arrival may be relative to a pose of XR device 806, for example, relative to a center of an FOV of XR device 806.

In some aspects, to determine the direction related to the sound source, wherein the computing device (or one or more components thereof) may: estimate a location of the sound source based on the audio data; and determine the direction based on the estimated location of the sound source. For example, XR device 806 may estimate a location of phone 810 (e.g., relative to XR device 806). Further, XR device 806 may determine the direction between the center of the FOV of XR device 806 and phone 810 based on the estimated location of phone 810.

At block 1404, the computing device (or one or more components thereof) may determine a probability that a user of the device will look toward the sound source. For example, XR device 806 may determine a probability that user 804 will look toward phone 810.

In some aspects, the probability is determined based on gaze data associated with the user of the device, wherein the gaze data is based on at least one of head or eye movements of the user. For example, XR device 806 may track gaze data of user 804. For instance, XR device 806 may track whether user 804 looks at phone 810 when phone 810 rings in a number of instances. XR device 806 may predict whether user 804 may look at phone 810 based on the historical gaze data relative to user 804 and/or to phone 810.

In some aspects, the probability is determined based on a classification of a sound from the sound source. For example, XR device 806 may determine the probability regarding whether user 804 will look at phone 810 based on a classification of the sound emitted by phone 810. For example, XR device 806 may determine that phone 810 is a phone and predict the probability that user 804 will look at phone 810 based on the determination that phone 810 is a phone.

At block 1406, the computing device (or one or more components thereof) may based on the probability exceeding a threshold, determine a region of interest (ROI) of a field of view (FOV) of a camera of the device based on the direction. For example, XR device 806 may determine ROI 824 based on the determined probability that user 804 will look toward phone 810.

In some aspects, to determine the ROI, the computing device (or one or more components thereof) may: predict a change in an eye angle of at least one eye of a user of the device; predict a change in a head angle of a head of the user; and determine the ROI based on the predicted change in the eye angle and the predicted change in the head angle. For example, XR device 806 may predict a change in an eye angle of user 804 and/or a change in head angle of user 804. For instance, based on an angle between a center of an FOV of XR device 806 and phone 810, XR device 806 may predict whether user 804 will turn their head to look at phone 810 or just turn their eyes to look at phone 810. XR device 806 may determine ROI 824 based on the prediction regarding whether user 804 will turn their head or turn their eyes. ]

In some aspects, to determine the ROI the computing device (or one or more components thereof) may adjust a previous ROI based on the direction. For example, XR device 806 may adjust ROI 814 (e.g., to extend margins of ROI 814 toward phone 810 and/or to reduce margins of ROI 814 in directions that are not toward ROI 824) to implement ROI 824.

In some aspects, to adjust the previous ROI, the computing device (or one or more components thereof) may reduce a size of the previous ROI. For example, XR device 806 may adjust ROI 814 (e.g., to reduce margins of ROI 814 in directions that are not toward ROI 824) to implement ROI 824.

In some aspects, the ROI is further determined based on gaze information determined from images of eyes of a user of the device. For example, XR device 806 may determine ROI 824 based on a current gaze of user 804.

At block 1408, the computing device (or one or more components thereof) may process image data captured by the camera based on the ROI. For example, XR device 806 may process image data based on ROI 824.

In some aspects, to process the image data based on the ROI, the at least one processor is configured to obtain the image data from memory based on the ROI. For example, to process image data based on ROI 824, XR device 806 may retrieve pixels related to ROI 824 at a higher resolution than pixels related to other areas of the FOV of XR device 806.

In some aspects, the computing device (or one or more components thereof) may cause an image sensor to capture further image data based on the ROI. For example, XR device 806 may cause an image sensor of XR device 806 to capture further image data based on ROI 824.

In some examples, as noted previously, the methods described herein (e.g., process 1100 of FIG. 11, process 1400 of FIG. 14, and/or other methods described herein) can be performed, in whole or in part, by a computing device or apparatus. In one example, one or more of the methods can be performed by XR system 100 of FIG. 1, XR system 200 of FIG. 2, system 300 of FIG. 3, system 600 of FIG. 6, system 700 of FIG. 7, system 900 of FIG. 9, system 1200 of FIG. 12, system 1300 of FIG. 13, or by another system or device. In another example, one or more of the methods (e.g., process 1100, process 1400, and/or other methods described herein) can be performed, in whole or in part, by the computing-device architecture 1700 shown in FIG. 17. For instance, a computing device with the computing-device architecture 1700 shown in FIG. 17 can include, or be included in, the components of the XR system 100 of FIG. 1, XR system 200 of FIG. 2, system 300 of FIG. 3, system 600 of FIG. 6, system 700 of FIG. 7, system 900 of FIG. 9, system 1200 of FIG. 12, system 1300 of FIG. 13 and can implement the operations of process 1100, process 1400, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1100, process 1400, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1100, process 1400, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

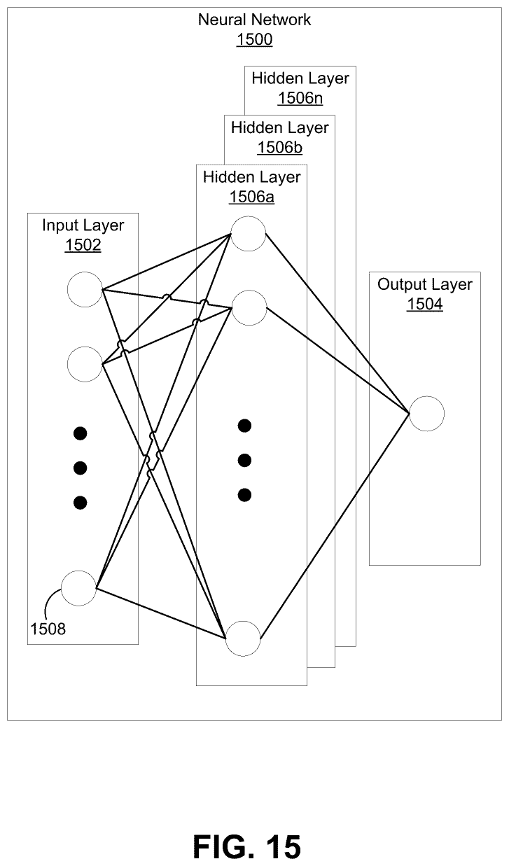

FIG. 15 is an illustrative example of a neural network 1500 (e.g., a deep-learning neural network) that can be used to implement machine-learning based gaze detection, gaze prediction, sound localization, sound classification feature segmentation, implicit-neural-representation generation, rendering, classification, object detection, image recognition (e.g., face recognition, object recognition, scene recognition, etc.), feature extraction, authentication,, and/or automation. For example, neural network 1500 may be an example of, or can implement, gaze estimator 710, audio-source analyzer 912, audio-source localizer 916, gaze detector 930, ROI determiner 920, pose determiner 936, margin determiner 948, and/or personalizer 952.

An input layer 1502 includes input data. In one illustrative example, input layer 1502 can include data representing facial images 708, processed audio signals 910, audio information 914, facial images 928, ROI 924, pose data 934, accuracy data 944, and/or response data 946. Neural network 1500 includes multiple hidden layers, for example, hidden layers 1506a, 1506b, through 1506n. The hidden layers 1506a, 1506b, through hidden layer 1506n include “n” number of hidden layers, where “n” is an integer greater than or equal to one. The number of hidden layers can be made to include as many layers as needed for the given application. Neural network 1500 further includes an output layer 1504 that provides an output resulting from the processing performed by the hidden layers 1506a, 1506b, through 1506n. In one illustrative example, output layer 1504 can provide ROI 712, audio information 914, sound-source location information 918, gaze information 932, ROI 924, pose information 938, margin data 950, and/or priority data 954.

Neural network 1500 may be, or may include, a multi-layer neural network of interconnected nodes. Each node can represent a piece of information. Information associated with the nodes is shared among the different layers and each layer retains information as information is processed. In some cases, neural network 1500 can include a feed-forward network, in which case there are no feedback connections where outputs of the network are fed back into itself. In some cases, neural network 1500 can include a recurrent neural network, which can have loops that allow information to be carried across nodes while reading in input.

Information can be exchanged between nodes through node-to-node interconnections between the various layers. Nodes of input layer 1502 can activate a set of nodes in the first hidden layer 1506a. For example, as shown, each of the input nodes of input layer 1502 is connected to each of the nodes of the first hidden layer 1506a. The nodes of first hidden layer 1506a can transform the information of each input node by applying activation functions to the input node information. The information derived from the transformation can then be passed to and can activate the nodes of the next hidden layer 1506b, which can perform their own designated functions. Example functions include convolutional, up-sampling, data transformation, and/or any other suitable functions. The output of the hidden layer 1506b can then activate nodes of the next hidden layer, and so on. The output of the last hidden layer 1506n can activate one or more nodes of the output layer 1504, at which an output is provided. In some cases, while nodes (e.g., node 1508) in neural network 1500 are shown as having multiple output lines, a node has a single output and all lines shown as being output from a node represent the same output value.

In some cases, each node or interconnection between nodes can have a weight that is a set of parameters derived from the training of neural network 1500. Once neural network 1500 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1500 to be adaptive to inputs and able to learn as more and more data is processed.

Neural network 1500 may be pre-trained to process the features from the data in the input layer 1502 using the different hidden layers 1506a, 1506b, through 1506n in order to provide the output through the output layer 1504. In an example in which neural network 1500 is used to identify features in images, neural network 1500 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1500 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 1500 is trained well enough so that the weights of the layers are accurately tuned.

For the example of identifying objects in images, the forward pass can include passing a training image through neural network 1500. The weights are initially randomized before neural network 1500 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1500, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1500 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½ (target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1500 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−η dL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 1500 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1500 can include any other deep network other than a CNN, such as an autoencoder, a deep belief nets (DBNs), a Recurrent Neural Networks (RNNs), among others.

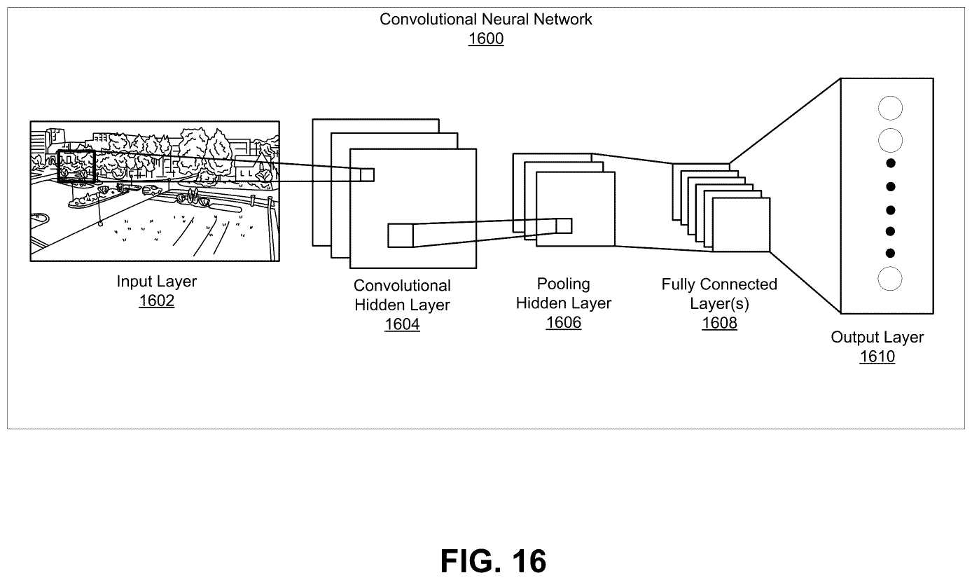

FIG. 16 is an illustrative example of a convolutional neural network (CNN) 1600. The input layer 1602 of the CNN 1600 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1604, an optional non-linear activation layer, a pooling hidden layer 1606, and fully connected layer 1608 (which fully connected layer 1608 can be hidden) to get an output at the output layer 1610. While only one of each hidden layer is shown in FIG. 16, one of ordinary skill will appreciate that multiple convolutional hidden layers, non-linear layers, pooling hidden layers, and/or fully connected layers can be included in the CNN 1600. As previously described, the output can indicate a single class of an object or can include a probability of classes that best describe the object in the image.

The first layer of the CNN 1600 can be the convolutional hidden layer 1604. The convolutional hidden layer 1604 can analyze image data of the input layer 1602. Each node of the convolutional hidden layer 1604 is connected to a region of nodes (pixels) of the input image called a receptive field. The convolutional hidden layer 1604 can be considered as one or more filters (each filter corresponding to a different activation or feature map), with each convolutional iteration of a filter being a node or neuron of the convolutional hidden layer 1604. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1604. Each connection between a node and a receptive field for that node learns a weight and, in some cases, an overall bias such that each node learns to analyze its particular local receptive field in the input image. Each node of the convolutional hidden layer 1604 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1604 is due to each node of the convolutional layer being applied to its corresponding receptive field. For example, a filter of the convolutional hidden layer 1604 can begin in the top-left corner of the input image array and can convolve around the input image. As noted above, each convolutional iteration of the filter can be considered a node or neuron of the convolutional hidden layer 1604. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1604. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1604.

The mapping from the input layer to the convolutional hidden layer 1604 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1604 can include several activation maps in order to identify multiple features in an image. The example shown in FIG. 16 includes three activation maps. Using three activation maps, the convolutional hidden layer 1604 can detect three different kinds of features, with each feature being detectable across the entire image.

In some examples, a non-linear hidden layer can be applied after the convolutional hidden layer 1604. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1600 without affecting the receptive fields of the convolutional hidden layer 1604.

The pooling hidden layer 1606 can be applied after the convolutional hidden layer 1604 (and after the non-linear hidden layer when used). The pooling hidden layer 1606 is used to simplify the information in the output from the convolutional hidden layer 1604. For example, the pooling hidden layer 1606 can take each activation map output from the convolutional hidden layer 1604 and generates a condensed activation map (or feature map) using a pooling function. Max-pooling is one example of a function performed by a pooling hidden layer. Other forms of pooling functions be used by the pooling hidden layer 1606, such as average pooling, L2-norm pooling, or other suitable pooling functions. A pooling function (e.g., a max-pooling filter, an L2-norm filter, or other suitable pooling filter) is applied to each activation map included in the convolutional hidden layer 1604. In the example shown in FIG. 16, three pooling filters are used for the three activation maps in the convolutional hidden layer 1604.

In some examples, max-pooling can be used by applying a max-pooling filter (e.g., having a size of 2×2) with a stride (e.g., equal to a dimension of the filter, such as a stride of 2) to an activation map output from the convolutional hidden layer 1604. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1604 having a dimension of 24×24 nodes, the output from the pooling hidden layer 1606 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1600.

The final layer of connections in the network is a fully-connected layer that connects every node from the pooling hidden layer 1606 to every one of the output nodes in the output layer 1610. Using the example above, the input layer includes 28×28 nodes encoding the pixel intensities of the input image, the convolutional hidden layer 1604 includes 3×24×24 hidden feature nodes based on application of a 5×5 local receptive field (for the filters) to three activation maps, and the pooling hidden layer 1606 includes a layer of 3×12×12 hidden feature nodes based on application of max-pooling filter to 2×2 regions across each of the three feature maps. Extending this example, the output layer 1610 can include ten output nodes. In such an example, every node of the 3×12×12 pooling hidden layer 1606 is connected to every node of the output layer 1610.

The fully connected layer 1608 can obtain the output of the previous pooling hidden layer 1606 (which should represent the activation maps of high-level features) and determines the features that most correlate to a particular class. For example, the fully connected layer 1608 can determine the high-level features that most strongly correlate to a particular class and can include weights (nodes) for the high-level features. A product can be computed between the weights of the fully connected layer 1608 and the pooling hidden layer 1606 to obtain probabilities for the different classes. For example, if the CNN 1600 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1610 can include an M-dimensional vector (in the prior example, M=10). M indicates the number of classes that the CNN 1600 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 17 illustrates an example computing-device architecture 1700 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1700 may include, implement, or be included in any or all of XR system 100 of FIG. 1, XR system 200 of FIG. 2, system 300 of FIG. 3, system 600 of FIG. 6, system 700 of FIG. 7, system 900 of FIG. 9, system 1200 of FIG. 12, system 1300 of FIG. 13 and/or other devices, modules, or systems described herein. Additionally or alternatively, computing-device architecture 1700 may be configured to perform process 1100, process 1400, and/or other process described herein.

The components of computing-device architecture 1700 are shown in electrical communication with each other using connection 1712, such as a bus. The example computing-device architecture 1700 includes a processing unit (CPU or processor) 1702 and computing device connection 1712 that couples various computing device components including computing device memory 1710, such as read only memory (ROM) 1708 and random-access memory (RAM) 1706, to processor 1702.

Computing-device architecture 1700 can include a cache of high-speed memory connected directly with, in close proximity to, or integrated as part of processor 1702. Computing-device architecture 1700 can copy data from memory 1710 and/or the storage device 1714 to cache 1704 for quick access by processor 1702. In this way, the cache can provide a performance boost that avoids processor 1702 delays while waiting for data. These and other modules can control or be configured to control processor 1702 to perform various actions. Other computing device memory 1710 may be available for use as well. Memory 1710 can include multiple different types of memory with different performance characteristics. Processor 1702 can include any general-purpose processor and a hardware or software service, such as service 1 1716, service 2 1718, and service 3 1720 stored in storage device 1714, configured to control processor 1702 as well as a special-purpose processor where software instructions are incorporated into the processor design. Processor 1702 may be a self-contained system, containing multiple cores or processors, a bus, memory controller, cache, etc. A multi-core processor may be symmetric or asymmetric.

To enable user interaction with the computing-device architecture 1700, input device 1722 can represent any number of input mechanisms, such as a microphone for speech, a touch-sensitive screen for gesture or graphical input, keyboard, mouse, motion input, speech and so forth. Output device 1724 can also be one or more of a number of output mechanisms known to those of skill in the art, such as a display, projector, television, speaker device, etc. In some instances, multimodal computing devices can enable a user to provide multiple types of input to communicate with computing-device architecture 1700. Communication interface 1726 can generally govern and manage the user input and computing device output. There is no restriction on operating on any particular hardware arrangement and therefore the basic features here may easily be substituted for improved hardware or firmware arrangements as they are developed.

Storage device 1714 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1706, read only memory (ROM) 1708, and hybrids thereof. Storage device 1714 can include services 1716, 1718, and 1720 for controlling processor 1702. Other hardware or software modules are contemplated. Storage device 1714 can be connected to the computing device connection 1712. In one aspect, a hardware module that performs a particular function can include the software component stored in a computer-readable medium in connection with the necessary hardware components, such as processor 1702, connection 1712, output device 1724, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for processing images, the apparatus comprising: at least one memory; and at least one processor coupled to the at least one memory and configured to: determine a direction related to a sound source in an environment based on audio data captured by a microphone of a device in the environment; determine a probability that a user of the device will look toward the sound source; based on the probability exceeding a threshold, determine a region of interest (ROI) of a field of view (FOV) of a camera of the device based on the direction; and process image data captured by the camera based on the ROI.
Aspect 2. The apparatus of aspect 1, wherein the at least one processor is configured to cause an image sensor to capture further image data based on the ROI.
Aspect 3. The apparatus of any one of aspects 1 or 2, wherein, to determine the direction related to the sound source, the at least one processor is configured to: estimate an angle of arrival of sound from the sound source based on the audio data, wherein the angle of arrival is relative to a pose of the device; and determine the direction based on the estimated angle of arrival of the sound source.
Aspect 4. The apparatus of any one of aspects 1 to 3, wherein, to determine the direction related to the sound source, wherein the at least one processor is configured to: estimate a location of the sound source based on the audio data; and determine the direction based on the estimated location of the sound source.
Aspect 5. The apparatus of any one of aspects 1 to 4, wherein the probability is determined based on gaze data associated with the user of the device, wherein the gaze data is based on at least one of head or eye movements of the user.
Aspect 6. The apparatus of any one of aspects 1 to 5, wherein the probability is determined based on a classification of a sound from the sound source.
Aspect 7. The apparatus of any one of aspects 1 to 6, wherein, to determine the ROI, the at least one processor is configured to: predict a change in an eye angle of at least one eye of a user of the device; predict a change in a head angle of a head of the user; and determine the ROI based on the predicted change in the eye angle and the predicted change in the head angle.
Aspect 8. The apparatus of any one of aspects 1 to 7, wherein, to determine the ROI the at least one processor is configured to adjust a previous ROI based on the direction.
Aspect 9. The apparatus of aspect 8, wherein, to adjust the previous ROI, the at least one processor is configured to reduce a size of the previous ROI.
Aspect 10. The apparatus of any one of aspects 1 to 9, wherein the ROI is further determined based on gaze information determined from images of eyes of a user of the device.
Aspect 11. The apparatus of any one of aspects 1 to 10, wherein, to process the image data based on the ROI, the at least one processor is configured to obtain the image data from memory based on the ROI.
Aspect 12. A method for processing images, the method comprising: determining a direction related to a sound source in an environment based on audio data captured by a microphone of a device in the environment; determining a probability that a user of the device will look toward the sound source; based on the probability exceeding a threshold, determining a region of interest (ROI) of a field of view (FOV) of a camera of the device based on the direction; and processing image data captured by the camera based on the ROI.
Aspect 13. The method of aspect 12, further comprising capturing the image data based on the ROI.
Aspect 14. The method of any one of aspects 12 or 13, wherein determining the direction related to the sound source comprises: estimating an angle of arrival of sound from the sound source based on the audio data, wherein the angle of arrival is relative to a pose of the device; and determining the direction based on the estimated angle of arrival of the sound source.
Aspect 15. The method of any one of aspects 12 to 14, wherein determining the direction related to the sound source comprises: estimating a location of the sound source based on the audio data; and determining the direction based on the estimated location of the sound source.
Aspect 16. The method of any one of aspects 12 to 15, wherein the probability is determined based on gaze data associated with the user of the device, wherein the gaze data is based on at least one of head or eye movements of the user.
Aspect 17. The method of any one of aspects 12 to 16, wherein the probability is determined based on a classification of a sound from the sound source.
Aspect 18. The method of any one of aspects 12 to 17, wherein determining the ROI comprises: predicting a change in an eye angle of at least one eye of a user of the device; predicting a change in a head angle of a head of the user; and determining the ROI based on the predicted change in the eye angle and the predicted change in the head angle.
Aspect 19. The method of any one of aspects 12 to 18, wherein determining the ROI comprises adjusting a previous ROI based on the direction.
Aspect 20. The method of aspect 19, wherein adjusting the previous ROI comprises reducing a size of the previous ROI.
Aspect 21. The method of any one of aspects 12 to 20, wherein the ROI is further determined based on gaze information determined from images of eyes of a user of the device.
Aspect 22. The method of any one of aspects 12 to 21, wherein processing the image data based on the ROI comprises obtaining the image data from memory based on the ROI.
Aspect 23. A non-transitory computer-readable storage medium having stored thereon instructions that, when executed by at least one processor, cause the at least one processor to perform operations according to any of aspects 12 to 22.
Aspect 24. An apparatus for processing images, the apparatus comprising one or more means for perform operations according to any of aspects 12 to 22.

What is claimed is:

1. An apparatus for processing images, the apparatus comprising:
at least one memory; and
at least one processor coupled to the at least one memory and configured to:
determine a direction related to a sound source in an environment based on audio data captured by a microphone of a device in the environment;
determine a probability that a user of the device will look toward the sound source;
based on the probability exceeding a threshold, determine a region of interest (ROI) of a field of view (FOV) of a camera of the device based on the direction; and
process image data captured by the camera based on the ROI.

2. The apparatus of claim 1, wherein the at least one processor is configured to cause an image sensor to capture further image data based on the ROI.

3. The apparatus of claim 1, wherein, to determine the direction related to the sound source, the at least one processor is configured to:
estimate an angle of arrival of sound from the sound source based on the audio data, wherein the angle of arrival is relative to a pose of the device; and
determine the direction based on the estimated angle of arrival of the sound source.

4. The apparatus of claim 1, wherein, to determine the direction related to the sound source, wherein the at least one processor is configured to:
estimate a location of the sound source based on the audio data; and
determine the direction based on the estimated location of the sound source.

5. The apparatus of claim 1, wherein the probability is determined based on gaze data associated with the user of the device, wherein the gaze data is based on at least one of head or eye movements of the user.

6. The apparatus of claim 1, wherein the probability is determined based on a classification of a sound from the sound source.

7. The apparatus of claim 1, wherein, to determine the ROI, the at least one processor is configured to:
predict a change in an eye angle of at least one eye of a user of the device;
predict a change in a head angle of a head of the user; and
determine the ROI based on the predicted change in the eye angle and the predicted change in the head angle.

8. The apparatus of claim 1, wherein, to determine the ROI the at least one processor is configured to adjust a previous ROI based on the direction.

9. The apparatus of claim 8, wherein, to adjust the previous ROI, the at least one processor is configured to reduce a size of the previous ROI.

10. The apparatus of claim 1, wherein the ROI is further determined based on gaze information determined from images of eyes of a user of the device.

11. The apparatus of claim 1, wherein, to process the image data based on the ROI, the at least one processor is configured to obtain the image data from memory based on the ROI.

12. A method for processing images, the method comprising:
determining a direction related to a sound source in an environment based on audio data captured by a microphone of a device in the environment;
determining a probability that a user of the device will look toward the sound source;
based on the probability exceeding a threshold, determining a region of interest (ROI) of a field of view (FOV) of a camera of the device based on the direction; and
processing image data captured by the camera based on the ROI.

13. The method of claim 12, further comprising capturing the image data based on the ROI.

14. The method of claim 12, wherein determining the direction related to the sound source comprises:
estimating an angle of arrival of sound from the sound source based on the audio data, wherein the angle of arrival is relative to a pose of the device; and
determining the direction based on the estimated angle of arrival of the sound source.

15. The method of claim 12, wherein determining the direction related to the sound source comprises:
estimating a location of the sound source based on the audio data; and
determining the direction based on the estimated location of the sound source.

16. The method of claim 12, wherein the probability is determined based on gaze data associated with the user of the device, wherein the gaze data is based on at least one of head or eye movements of the user.

17. The method of claim 12, wherein the probability is determined based on a classification of a sound from the sound source.

18. The method of claim 12, wherein determining the ROI comprises:
predicting a change in an eye angle of at least one eye of a user of the device;
predicting a change in a head angle of a head of the user; and
determining the ROI based on the predicted change in the eye angle and the predicted change in the head angle.

19. The method of claim 12, wherein determining the ROI comprises adjusting a previous ROI based on the direction.

20. The method of claim 19, wherein adjusting the previous ROI comprises reducing a size of the previous ROI.
